(19) United States
(12) Patent Application Publication
(10) Pub. No.: US 2025/0020794 A1
(43) Pub. Date: Jan. 16, 2025

(54) MEASUREMENT METHOD, APPARATUS, AND DEVICE

(71) Applicant: HUAWEI TECHNOLOGIES CO., LTD., Shenzhen (CN)

(72) Inventors: Gerile NAREN, Shenzhen (CN); Xiao HAN, Shenzhen (CN); Mengshi HU, Shenzhen (CN); Rui DU, Singapore (SG); Jian YU, Shenzhen (CN); Yunbo LI, Shenzhen (CN); Chenchen LIU, Shenzhen (CN)

(21) Appl. No.: 18/899,137

(22) Filed: Sep. 27, 2024

Related U.S. Application Data
(63) Continuation of application No. PCT/CN2023/078294, filed on Feb. 25, 2023.

(30) Foreign Application Priority Data
Mar. 28, 2022 (CN) 202210311941.1
Jul. 29, 2022 (CN) 202210908243.X

(51) Int. Cl. G01S 13/76; G01S 7/00; G01S 13/87

(52) U.S. Cl. CPC G01S 13/765; G01S 7/006; G01S 13/87

(57) ABSTRACT

Embodiments of this application provide a measurement method, an apparatus, and a device. The embodiments may be applied to wireless local area network systems of the 802.11 series protocols such as 802.11be, Wi-Fi 7, EHT, Wi-Fi 8, 802.11bf, and sensing. The embodiments provide an approach of generating, by a first device, a sensing measurement setup request frame that includes first ranging indication information used to request a second device to perform ranging measurement in a sensing measurement process. The approach then sends, by the first device, the sensing measurement setup request frame to the second device.

### CROSS-REFERENCE TO RELATED APPLICATIONS

This application is a continuation of International Application No. PCT/CN2023/078294, filed on Feb. 25, 2023, which claims priority to Chinese Patent Application No. 202210311941.1, filed on Mar. 28, 2022, and Chinese Patent Application No. 202210908243.X, filed on Jul. 29, 2022. All of the aforementioned patent applications are hereby incorporated by reference in their entireties.

### TECHNICAL FIELD

This application relates to the field of communication technologies, and in particular, to a measurement method, an apparatus, and a device.

### BACKGROUND

Due to wide deployment of wireless fidelity (Wi-Fi) devices and an increase in sensing requirements, sensing performed by using a widely available Wi-Fi device is a hot topic of current research. For example, a signal sent by the Wi-Fi device is usually received after being reflected, diffracted, and scattered by various obstacles. A wireless signal affected by various obstacles is analyzed, for example, channel state information (CSI), so that an ambient environment can be inferred and sensed, thereby implementing a sensing procedure. Therefore, for the Wi-Fi device, an implementation of the sensing procedure is worth researching.

### SUMMAPY

Embodiments of this application provide a measurement method, an apparatus, and a device. In the method, a type of sensing trigger frames is designed, so that the type of sensing trigger frames can be identified by a device supporting sensing, and the device supporting sensing can have a function of trigger-based sensing measurement.

According to a first aspect, an embodiment of this application provides a measurement method. The measurement method is performed by a first device. The first device may be an access point AP. The first device sends a sensing sounding trigger frame to a second device, to trigger the second device to send a first null data packet (NDP) to the first device. The first NDP may be used for sensing measurement. The first device receives the first NDP, and sends a second NDP to the second device. A sensing measurement result of the second device is determined based on the second NDP.

In the method, the sensing sounding trigger frame designed in embodiments of this application is sent by the first device to the second device. The sensing sounding trigger frame may be identified by the second device (for example, a sensing device), and a function of the sensing sounding trigger frame includes triggering the second device to send information related to sensing measurement to the first device, so that the sensing device can have a function of trigger-based sensing measurement.

In an embodiment, the second device is a sensing device.

The sensing sounding trigger frame carries a measurement setup identifier used for sensing measurement, and the measurement setup identifier is carried in a first field and/or a second field in a common information field of the sensing sounding trigger frame, or carried in a user information list field of the sensing sounding trigger frame.

In the method, the measurement setup identifier field that is used for sensing measurement and that is carried in the sensing sounding trigger frame is designed, so that a design manner of the sensing sounding trigger frame is more flexible. This helps the second device identify the measurement setup identifier used for sensing measurement.

In an embodiment, the sensing sounding trigger frame carries a measurement instance identifier used for sensing measurement, and the measurement instance identifier is carried in the first field and/or the second field in the common information field of the sensing sounding trigger frame, or carried in the user information list field of the sensing sounding trigger frame.

In the method, the measurement instance identifier field that is used for sensing measurement and that is carried in the sensing sounding trigger frame is designed, so that the design manner of the sensing sounding trigger frame is more flexible. This helps the second device identify the measurement instance identifier used for sensing measurement.

In an embodiment, both the measurement setup identifier and the measurement instance identifier are carried in the second field in the common information field of the sensing sounding trigger frame, and a length of the second field is b bits, where b is a positive integer.

In an embodiment, b is greater than or equal to 8.

In the method, the second field of the sensing sounding trigger frame may be expanded, so that both the measurement setup identifier and the measurement instance identifier may be carried in the second field, and the design manner of the sensing sounding trigger frame is more flexible.

In an embodiment, the sensing sounding trigger frame carries first indication information, the first indication information is carried in the second field in the common information field of the sensing sounding trigger frame, and a value of the first indication information in the sensing sounding trigger frame is a first value.

In the method, the sensing sounding trigger frame may be designed to use a frame structure and a field similar to those of an existing trigger frame, to help the second device identify the sensing sounding trigger frame.

In an embodiment, before sending the sensing sounding trigger frame to the second device, the first device sends a sensing polling trigger frame to the second device, and receives a first response frame for the sensing polling trigger frame from the second device. The first response frame is used to confirm that the second device participates in the sensing measurement.

In the method, the sensing polling trigger frame designed in embodiments of this application is sent by the first device to the second device. The sensing polling trigger frame may be identified by the second device (for example, a sensing device), so that the sensing device can have the function of trigger-based sensing measurement.

In an embodiment, the second device is a sensing device.

The sensing polling trigger frame carries a measurement setup identifier used for sensing measurement, and the measurement setup identifier is carried in a first field and/or a second field in a common information field of the sensing polling trigger frame.

In the method, the measurement setup identifier field that is used for sensing measurement and that is carried in the sensing polling trigger frame is designed, so that a design manner of the sensing polling trigger frame is more flexible. This helps the second device identify the measurement setup identifier used for sensing measurement.

In an embodiment, the sensing polling trigger frame carries a measurement instance identifier used for sensing measurement, and the measurement instance identifier is carried in the first field and/or the second field in the common information field of the sensing polling trigger frame.

In the method, the measurement instance identifier field that is used for sensing measurement and that is carried in the sensing polling trigger frame is designed, so that the design manner of the sensing polling trigger frame is more flexible. This helps the second device identify the measurement instance identifier used for sensing measurement.

In an embodiment, both the measurement setup identifier and the measurement instance identifier are carried in the second field in the common information field of the sensing polling trigger frame, and a length of the second field is b bits, where b is a positive integer.

In an embodiment, b is greater than or equal to 8.

In the method, the second field of the sensing polling trigger frame may be expanded, so that both the measurement setup identifier and the measurement instance identifier may be carried in the second field, and the design manner of the sensing polling trigger frame is more flexible.

In an embodiment, the sensing polling trigger frame carries first indication information, the first indication information is carried in the second field in the common information field of the sensing polling trigger frame, and a value of the first indication information in the sensing polling trigger frame is a second value.

In the method, the sensing polling trigger frame may be designed to use a frame structure and a field similar to those of an existing trigger frame, to help the second device identify the sensing polling trigger frame.

In an embodiment, the first device sends a sensing reporting trigger frame to the second device, and the first device receives a second response frame for the sensing reporting trigger frame from the second device. The second response frame includes the sensing measurement result of the second device.

In the method, the sensing reporting trigger frame designed in embodiments of this application may be identified by the second device (for example, a sensing device), so that the sensing device can have the function of trigger-based sensing measurement.

In an embodiment, the second device is a sensing device.

The sensing reporting trigger frame carries a measurement setup identifier used for sensing measurement, and the measurement setup identifier is carried in a first field and/or a second field in a common information field of the sensing reporting trigger frame, or carried in a user information list field of the sensing reporting trigger frame.

In the method, the measurement setup identifier field that is used for sensing measurement and that is carried in the sensing reporting trigger frame is designed, so that a design manner of the sensing reporting trigger frame is more flexible. This helps the second device identify the measurement setup identifier used for sensing measurement.

In an embodiment, the sensing reporting trigger frame carries a measurement instance identifier used for sensing measurement, and the measurement instance identifier is carried in the first field and/or the second field in the common information field of the sensing reporting trigger frame, or carried in the user information list field of the sensing reporting trigger frame.

In the method, the measurement instance identifier field that is used for sensing measurement and that is carried in the sensing reporting trigger frame is designed, so that the design manner of the sensing reporting trigger frame is more flexible. This helps the second device identify the measurement instance identifier used for sensing measurement.

In an embodiment, both the measurement setup identifier and the measurement instance identifier are carried in the second field in the common information field, and a length of the second field is b bits, where b is a positive integer.

In an embodiment, b is greater than or equal to 8.

In the method, the second field in the common information field of the sensing reporting trigger frame may be expanded, so that both the measurement setup identifier and the measurement instance identifier may be carried in the second field, and the design manner of the sensing reporting trigger frame is more flexible.

In an embodiment, the sensing reporting trigger frame carries first indication information, the first indication information is carried in a trigger dependent common information field of the sensing reporting trigger frame, and a value of the first indication information in the sensing reporting trigger frame is a third value.

In the method, the sensing reporting trigger frame may be designed to use a frame structure and a field similar to those of an existing trigger frame, to help the second device identify the sensing reporting trigger frame.

In an embodiment, an NDPA (null data packet announcement) carries one or more of the following information:
an association identifier, where the association identifier is associated with the sensing device;
second indication information, where the second indication information indicates the sensing device to perform sensing measurement;
a measurement setup identifier used for sensing measurement; and
a measurement instance identifier used for sensing measurement.

In the method, an NDPA is further designed in embodiments of this application, so that the second device can identify the NDPA as a sensing NDPA. This helps the second device implement a sensing measurement function.

In an embodiment, the second indication information is carried in a user information list field that corresponds to the sensing device and that is of the NDPA, or carried in a special user information field of the NDPA, or carried in a sounding dialog token field of the NDPA.

In an embodiment, the measurement setup identifier is carried in the user information list field that corresponds to the sensing device and that is of the NDPA, or carried in the special user information field of the NDPA, or carried in the sounding dialog token field of the NDPA.

In an embodiment, the measurement instance identifier is carried in the user information list field that corresponds to the sensing device and that is of the NDPA, or carried in the special user information field of the NDPA, or carried in the sounding dialog token field of the NDPA.

In an embodiment, the association identifier is carried in the user information list field that corresponds to the sensing device and that is of the NDPA, or carried in the special user information field of the NDPA.

In an embodiment, the second device is a sensing device.

A sensing trigger frame carries the second indication information, and the sensing trigger frame is the sensing sounding trigger frame, or the sensing polling trigger frame, or the sensing reporting trigger frame. The second indication information indicates the sensing device to perform sensing measurement. The second indication information is carried in a user information list field, or a first field or a second field in a common information field of the sensing trigger frame.

In the method, the sensing trigger frame designed in embodiments of this application reuses a field that is of an existing trigger frame and that indicates a device function, and specifically indicates, via the second indication information, the second device to perform sensing measurement. This helps the second device identify the second indication information, to perform sensing measurement.

According to a second aspect, this application provides a measurement method. The measurement method is performed by a second device. The second device may be a non-access point station (non-AP STA). The second device receives a sensing sounding trigger frame. The sensing sounding trigger frame is used to trigger the second device to send a first null data packet NDP, and the first NDP is used to perform sensing measurement. The second device sends the first NDP, and receives a second NDP sent by the first device. A sensing measurement result of the second device is determined based on the second NDP.

In the method, the sensing sounding trigger frame designed in embodiments of this application may be identified by the second device (for example, a sensing device), and a function of the sensing sounding trigger frame includes triggering the second device to send information related to sensing measurement to the first device, so that the sensing device can have a function of trigger-based sensing measurement.

In an embodiment, before receiving the second NDP sent by the first device, the second device further receives a null data packet announcement NDPA sent by the first device. The NDPA is used to notify the second device that the first device is to send the second NDP.

In an embodiment, the second device is a sensing device.

The sensing sounding trigger frame carries a measurement setup identifier used for sensing measurement, and the measurement setup identifier is carried in a first field and/or a second field in a common information field of the sensing sounding trigger frame, or carried in a user information list field of the sensing sounding trigger frame.

In the method, the measurement setup identifier field that is used for sensing measurement and that is carried in the sensing sounding trigger frame is designed, so that a design manner of the sensing sounding trigger frame is more flexible. This helps the second device identify the measurement setup identifier used for sensing measurement.

In an embodiment, the sensing sounding trigger frame carries a measurement instance identifier used for sensing measurement, and the measurement instance identifier is carried in the first field and/or the second field in the common information field of the sensing sounding trigger frame, or carried in the user information list field of the sensing sounding trigger frame.

In the method, the measurement instance identifier field that is used for sensing measurement and that is carried in the sensing sounding trigger frame is designed, so that the design manner of the sensing sounding trigger frame is more flexible. This helps the second device identify the measurement instance identifier used for sensing measurement.

In an embodiment, both the measurement setup identifier and the measurement instance identifier are carried in the second field in the common information field of the sensing sounding trigger frame, and a length of the second field is b bits, where b is a positive integer.

In an embodiment, b is greater than or equal to 8.

In the method, the second field of the sensing sounding trigger frame may be expanded, so that both the measurement setup identifier and the measurement instance identifier may be carried in the second field, and the design manner of the sensing sounding trigger frame is more flexible.

In an embodiment, the sensing sounding trigger frame carries first indication information, the first indication information is carried in the second field in the common information field of the sensing sounding trigger frame, and a value of the first indication information in the sensing sounding trigger frame is a first value.

In the method, the sensing sounding trigger frame may be designed to use a frame structure and a field similar to those of an existing trigger frame, to help the second device identify the sensing sounding trigger frame.

In an embodiment, before receiving the sensing sounding trigger frame, the second device receives a sensing polling trigger frame, and sends a first response frame for the sensing polling trigger frame. The first response frame is used to confirm that the second device participates in sensing measurement.

In the method, the sensing polling trigger frame designed in embodiments of this application may be identified by the second device (for example, a sensing device), so that the sensing device can have the function of trigger-based sensing measurement.

In an embodiment, the second device is a sensing device.

The sensing polling trigger frame carries a measurement setup identifier used for sensing measurement, and the measurement setup identifier is carried in a first field and/or a second field in a common information field of the sensing polling trigger frame.

In the method, the measurement setup identifier field that is used for sensing measurement and that is carried in the sensing polling trigger frame is designed, so that a design manner of the sensing polling trigger frame is more flexible. This helps the second device identify the measurement setup identifier used for sensing measurement.

In an embodiment, the sensing polling trigger frame carries a measurement instance identifier used for sensing measurement, and the measurement instance identifier is carried in the first field and/or the second field in the common information field of the sensing polling trigger frame.

In the method, the measurement instance identifier field that is used for sensing measurement and that is carried in the sensing polling trigger frame is designed, so that the design manner of the sensing polling trigger frame is more flexible. This helps the second device identify the measurement instance identifier used for sensing measurement.

In an embodiment, both the measurement setup identifier and the measurement instance identifier are carried in the second field in the common information field of the sensing polling trigger frame, and a length of the second field is b bits, where b is a positive integer.

In an embodiment, b is greater than or equal to 8.

In the method, the second field of the sensing polling trigger frame may be expanded, so that both the measurement setup identifier and the measurement instance identifier may be carried in the second field, and the design manner of the sensing polling trigger frame is more flexible.

In an embodiment, the sensing polling trigger frame carries first indication information, the first indication information is carried in the second field in the common information field of the sensing polling trigger frame, and a value of the first indication information in the sensing polling trigger frame is a second value.

In the method, the sensing polling trigger frame may be designed to use a frame structure and a field similar to those of an existing trigger frame, to help the second device identify the sensing polling trigger frame.

In an embodiment, the second device receives a sensing reporting trigger frame, and sends a second response frame for the sensing reporting trigger frame. The second response frame includes the sensing measurement result of the second device.

In the method, the sensing reporting trigger frame designed in embodiments of this application may be identified by the second device (for example, a sensing device), so that the sensing device can have the function of trigger-based sensing measurement.

In an embodiment, the second device is a sensing device.

The sensing reporting trigger frame carries a measurement setup identifier used for sensing measurement, and the measurement setup identifier is carried in a first field and/or a second field in a common information field of the sensing reporting trigger frame, or carried in a user information list field of the sensing reporting trigger frame.

In the method, the measurement setup identifier field that is used for sensing measurement and that is carried in the sensing reporting trigger frame is designed, so that a design manner of the sensing reporting trigger frame is more flexible. This helps the second device identify the measurement setup identifier used for sensing measurement.

In an embodiment, the sensing reporting trigger frame carries a measurement instance identifier used for sensing measurement, and the measurement instance identifier is carried in the first field and/or the second field in the common information field of the sensing reporting trigger frame, or carried in the user information list field of the sensing reporting trigger frame.

In the method, the measurement instance identifier field that is used for sensing measurement and that is carried in the sensing reporting trigger frame is designed, so that the design manner of the sensing reporting trigger frame is more flexible. This helps the second device identify the measurement instance identifier used for sensing measurement.

In an embodiment, both the measurement setup identifier and the measurement instance identifier are carried in the second field in the common information field, and a length of the second field is b bits, where b is a positive integer.

In an embodiment, b is greater than or equal to 8.

In the method, the second field in the common information field of the sensing reporting trigger frame may be expanded, so that both the measurement setup identifier and the measurement instance identifier may be carried in the second field, and the design manner of the sensing reporting trigger frame is more flexible.

In an embodiment, the sensing reporting trigger frame carries first indication information, the first indication information is carried in a trigger dependent common information field of the sensing reporting trigger frame, and a value of the first indication information in the sensing reporting trigger frame is a third value.

In the method, the sensing reporting trigger frame may be designed to use a frame structure and a field similar to those of an existing trigger frame, to help the second device identify the sensing reporting trigger frame.

In an embodiment, an NDPA carries one or more of the following information:
an association identifier, where the association identifier is associated with the sensing device;
second indication information, where the second indication information indicates the sensing device to perform sensing measurement;
a measurement setup identifier used for sensing measurement; and
a measurement instance identifier used for sensing measurement.

In the method, an NDPA is further designed in embodiments of this application, so that the second device can identify the NDPA as a sensing NDPA. This helps the second device implement a sensing measurement function.

In an embodiment, the second indication information is carried in a user information list field that corresponds to the sensing device and that is of the NDPA, or carried in a special user information field of the NDPA, or carried in a sounding dialog token field of the NDPA.

In an embodiment, the measurement setup identifier is carried in the user information list field that corresponds to the sensing device and that is of the NDPA, or carried in the special user information field of the NDPA, or carried in the sounding dialog token field of the NDPA.

In an embodiment, the measurement instance identifier is carried in the user information list field that corresponds to the sensing device and that is of the NDPA, or carried in the special user information field of the NDPA, or carried in the sounding dialog token field of the NDPA.

In an embodiment, the association identifier is carried in the user information list field that corresponds to the sensing device and that is of the NDPA, or carried in the special user information field of the NDPA.

In an embodiment, the second device is a sensing device.

A sensing trigger frame carries the second indication information, and the sensing trigger frame is the sensing sounding trigger frame, or the sensing polling trigger frame, or the sensing reporting trigger frame. The second indication information indicates the sensing device to perform sensing measurement. The second indication information is carried in a user information list field, or a first field or a second field in a common information field of the sensing trigger frame.

In the method, the sensing trigger frame designed in embodiments of this application reuses a field that is of an existing trigger frame and that indicates a device function, and specifically indicates, via the second indication information, the second device to perform sensing measurement. This helps the second device identify the second indication information, to perform sensing measurement.

According to a third aspect, an embodiment of this application provides another measurement method. The measurement method is performed by a second device. The second device may be a sensing non-AP STA. The second device sends a sensing null data packet announcement NDPA to the first device, and sends an initiator-to-responder null data packet I2R-NDP to the first device based on the sensing NDPA. The second device receives a responder-to-initiator null data packet R2I-NDP from the first device.

In the method, an AP may also participate in sensing as a sensing responder, and a sensing initiator is a non-AP STA. In this case, the sensing initiator can sense only one sensing responder at the same time. In other words, a sensing process described in this aspect is a sensing process with a non-trigger-based mechanism, that is, a one-to-one process. A sensing device may perform sensing measurement based on the NDP.

In an embodiment, the sensing NDPA carries third indication information, and the third indication information indicates the first device to perform sensing measurement.

In the method, the sensing NDPA designed in embodiments of this application uses a frame structure similar to that of an existing NDPA, and specifically indicates, via the third indication information, the first device to perform sensing measurement. This helps the first device identify the third indication information, to perform sensing measurement.

In an embodiment, the sensing NDPA carries a measurement setup identifier used for sensing measurement and a measurement instance identifier used for sensing measurement.

In an embodiment, the third indication information is carried in a user information list field that corresponds to the sensing device and that is of the sensing NDPA, or carried in a special user information field, or carried in a sounding dialog token field of the sensing NDPA.

In an embodiment, the measurement setup identifier is carried in the user information list field that corresponds to the sensing device and that is of the sensing NDPA, or carried in the special user information field, or carried in the sounding dialog token field of the sensing NDPA.

In an embodiment, the measurement instance identifier is carried in the user information list field that corresponds to the sensing device and that is of the sensing NDPA, or carried in the special user information field, or carried in the sounding dialog token field of the sensing NDPA.

In an embodiment, when the initiator-to-responder null data packet (I2R-NDP) is an NDP used for sensing measurement, the second device may further receive a sensing measurement result from the first device.

According to a fourth aspect, an embodiment of this application provides a communication apparatus. The communication apparatus includes a plurality of functional units, for example, including a communication unit. The communication unit is configured to send a sensing sounding trigger frame to a second device. The sensing sounding trigger frame is used to trigger the second device to send a first null data packet NDP, and the first NDP is used to perform sensing measurement. The communication unit is further configured to receive the first NDP. The communication unit is further configured to send a second NDP to the second device. A sensing measurement result of the second device is determined based on the second NDP.

In an embodiment, the second device is a sensing device.

The sensing sounding trigger frame carries a measurement setup identifier used for sensing measurement, and the measurement setup identifier is carried in a first field and/or a second field in a common information field of the sensing sounding trigger frame, or carried in a user information list field of the sensing sounding trigger frame.

In an embodiment, the sensing sounding trigger frame carries a measurement instance identifier used for sensing measurement, and the measurement instance identifier is carried in the first field and/or the second field in the common information field of the sensing sounding trigger frame, or carried in the user information list field of the sensing sounding trigger frame.

In an embodiment, both the measurement setup identifier and the measurement instance identifier are carried in the second field in the common information field of the sensing sounding trigger frame, and a length of the second field is b bits, where b is a positive integer.

In an embodiment, b is greater than or equal to 8.

In an embodiment, the sensing sounding trigger frame carries first indication information, the first indication information is carried in the second field in the common information field of the sensing sounding trigger frame, and a value of the first indication information in the sensing sounding trigger frame is a first value.

In an embodiment, before sending the sensing sounding trigger frame to the second device, the communication unit is further configured to:
send a sensing polling trigger frame to the second device; and
receive a first response frame for the sensing polling trigger frame from the second device, where the first response frame is used to confirm that the second device participates in the sensing measurement.

In an embodiment, the second device is a sensing device.

The sensing polling trigger frame carries a measurement setup identifier used for sensing measurement, and the measurement setup identifier is carried in a first field and/or a second field in a common information field of the sensing polling trigger frame.

In an embodiment, the sensing polling trigger frame carries a measurement instance identifier used for sensing measurement, and the measurement instance identifier is carried in the first field and/or the second field in the common information field of the sensing polling trigger frame.

In an embodiment, both the measurement setup identifier and the measurement instance identifier are carried in the second field in the common information field of the sensing polling trigger frame, and a length of the second field is b bits, where b is a positive integer.

In an embodiment, b is greater than or equal to 8.

In an embodiment, the sensing polling trigger frame carries first indication information, the first indication information is carried in the second field in the common information field of the sensing polling trigger frame, and a value of the first indication information in the sensing polling trigger frame is a second value.

In an embodiment, the communication unit is further configured to:
send a sensing reporting trigger frame to the second device; and
receive a second response frame for the sensing reporting trigger frame from the second device, where the second response frame includes the sensing measurement result of the second device.

In an embodiment, the second device is a sensing device.

The sensing reporting trigger frame carries a measurement setup identifier used for sensing measurement, and the measurement setup identifier is carried in a first field and/or a second field in a common information field of the sensing reporting trigger frame, or carried in a user information list field of the sensing reporting trigger frame.

In an embodiment, the sensing reporting trigger frame carries a measurement instance identifier used for sensing measurement, and the measurement instance identifier is carried in the first field and/or the second field in the common information field of the sensing reporting trigger frame, or carried in the user information list field of the sensing reporting trigger frame.

In an embodiment, both the measurement setup identifier and the measurement instance identifier are carried in the second field in the common information field, and a length of the second field is b bits, where b is a positive integer.

In an embodiment, b is greater than or equal to 8.

In an embodiment, the sensing reporting trigger frame carries first indication information, the first indication information is carried in a trigger dependent common information field of the sensing reporting trigger frame, and a value of the first indication information in the sensing reporting trigger frame is a third value.

In an embodiment, an NDPA carries one or more of the following information:
an association identifier, where the association identifier is associated with the sensing device;
second indication information, where the second indication information indicates the sensing device to perform sensing measurement;
a measurement setup identifier used for sensing measurement; and
a measurement instance identifier used for sensing measurement.

In an embodiment, the second indication information is carried in a user information list field that corresponds to the sensing device and that is of the NDPA, or carried in a special user information field of the NDPA, or carried in a sounding dialog token field of the NDPA.

In an embodiment, the measurement setup identifier is carried in the user information list field that corresponds to the sensing device and that is of the NDPA, or carried in the special user information field of the NDPA, or carried in the sounding dialog token field of the NDPA.

In an embodiment, the measurement instance identifier is carried in the user information list field that corresponds to the sensing device and that is of the NDPA, or carried in the special user information field of the NDPA, or carried in the sounding dialog token field of the NDPA.

In an embodiment, the association identifier is carried in the user information list field that corresponds to the sensing device and that is of the NDPA, or carried in the special user information field of the NDPA.

In an embodiment, the second device is a sensing device.

A sensing trigger frame carries the second indication information, and the sensing trigger frame is the sensing sounding trigger frame, or the sensing polling trigger frame, or the sensing reporting trigger frame. The second indication information indicates the sensing device to perform sensing measurement. The second indication information is carried in a user information list field, or a first field or a second field in a common information field of the sensing trigger frame.

According to a fifth aspect, an embodiment of this application provides a communication apparatus. The communication apparatus includes a plurality of functional units, for example, including a communication unit. The communication unit is configured to receive a sensing sounding trigger frame. The sensing sounding trigger frame is used to trigger a second device to send a first null data packet NDP, and the first NDP is used to perform sensing measurement. The communication unit is further configured to send the first NDP. The communication unit is further configured to receive a second NDP sent by the first device. A sensing measurement result of the second device is determined based on the second NDP.

In an embodiment, the communication unit is further configured to receive a null data packet announcement NDPA sent by the first device. The NDPA is used to notify the second device that the first device is to send the second NDP.

In an embodiment, the second device is a sensing device.

The sensing sounding trigger frame carries a measurement setup identifier used for sensing measurement, and the measurement setup identifier is carried in a first field and/or a second field in a common information field of the sensing sounding trigger frame, or carried in a user information list field of the sensing sounding trigger frame.

In an embodiment, the sensing sounding trigger frame carries a measurement instance identifier used for sensing measurement, and the measurement instance identifier is carried in the first field and/or the second field in the common information field of the sensing sounding trigger frame, or carried in the user information list field of the sensing sounding trigger frame.

In an embodiment, both the measurement setup identifier and the measurement instance identifier are carried in the second field in the common information field of the sensing sounding trigger frame, and a length of the second field is b bits, where b is a positive integer.

In an embodiment, b is greater than or equal to 8.

In an embodiment, the sensing sounding trigger frame carries first indication information, the first indication information is carried in the second field in the common information field of the sensing sounding trigger frame, and a value of the first indication information in the sensing sounding trigger frame is a first value.

In an embodiment, the communication unit is further configured to: receive a sensing polling trigger frame; and
send a first response frame for the sensing polling trigger frame, where the first
response frame is used to confirm that the second device participates in the sensing measurement.

In an embodiment, the second device is a sensing device.

The sensing polling trigger frame carries a measurement setup identifier used for sensing measurement, and the measurement setup identifier is carried in a first field and/or a second field in a common information field of the sensing polling trigger frame.

In an embodiment, the sensing polling trigger frame carries a measurement instance identifier used for sensing measurement, and the measurement instance identifier is carried in the first field and/or the second field in the common information field of the sensing polling trigger frame.

In an embodiment, both the measurement setup identifier and the measurement instance identifier are carried in the second field in the common information field of the sensing polling trigger frame, and a length of the second field is b bits, where b is a positive integer.

In an embodiment, b is greater than or equal to 8.

In an embodiment, the sensing polling trigger frame carries first indication information, the first indication information is carried in the second field in the common information field of the sensing polling trigger frame, and a value of the first indication information in the sensing polling trigger frame is a second value.

In an embodiment, the communication unit is further configured to:
receive a sensing reporting trigger frame; and
send a second response frame for the sensing reporting trigger frame, where the second response frame includes the sensing measurement result of the second device.

In an embodiment, the second device is a sensing device.

The sensing reporting trigger frame carries a measurement setup identifier used for sensing measurement, and the measurement setup identifier is carried in a first field and/or a second field in a common information field of the sensing reporting trigger frame, or carried in a user information list field of the sensing reporting trigger frame.

In an embodiment, the sensing reporting trigger frame carries a measurement instance identifier used for sensing measurement, and the measurement instance identifier is carried in the first field and/or the second field in the common information field of the sensing reporting trigger frame, or carried in the user information list field of the sensing reporting trigger frame.

In an embodiment, both the measurement setup identifier and the measurement instance identifier are carried in the second field in the common information field, and a length of the second field is b bits, where b is a positive integer.

In an embodiment, b is greater than or equal to 8.

In an embodiment, the sensing reporting trigger frame carries first indication information, the first indication information is carried in a trigger dependent common information field of the sensing reporting trigger frame, and a value of the first indication information in the sensing reporting trigger frame is a third value.

In an embodiment, an NDPA carries one or more of the following information:
an association identifier, where the association identifier is associated with the sensing device;
second indication information, where the second indication information indicates the sensing device to perform sensing measurement;
a measurement setup identifier used for sensing measurement; and
a measurement instance identifier used for sensing measurement.

In an embodiment, the second indication information is carried in a user information list field that corresponds to the sensing device and that is of the NDPA, or carried in a special user information field of the NDPA, or carried in a sounding dialog token field of the NDPA.

In an embodiment, the measurement setup identifier is carried in the user information list field that corresponds to the sensing device and that is of the NDPA, or carried in the special user information field of the NDPA, or carried in the sounding dialog token field of the NDPA.

In an embodiment, the measurement instance identifier is carried in the user information list field that corresponds to the sensing device and that is of the NDPA, or carried in the special user information field of the NDPA, or carried in the sounding dialog token field of the NDPA.

In an embodiment, the association identifier is carried in the user information list field that corresponds to the sensing device and that is of the NDPA, or carried in the special user information field of the NDPA.

In an embodiment, the second device is a sensing device.

A sensing trigger frame carries the second indication information, and the sensing trigger frame is the sensing sounding trigger frame, or the sensing polling trigger frame, or the sensing reporting trigger frame. The second indication information indicates the sensing device to perform sensing measurement. The second indication information is carried in a user information list field, or a first field or a second field in a common information field of the sensing trigger frame.

According to a sixth aspect, an embodiment of this application provides a communication apparatus. The communication apparatus includes a plurality of functional units, for example, including a communication unit. The communication unit is configured to send a sensing null data packet announcement NDPA to a first device. The communication unit is further configured to send an initiator-to-responder null data packet (I2R-NDP) to the first device based on the sensing NDPA. The communication unit is further configured to receive a responder-to-initiator null data packet R2I-NDP from the first device.

In an embodiment, the sensing NDPA carries third indication information, and the third indication information indicates the first device to perform sensing measurement.

In an embodiment, the sensing NDPA carries a measurement setup identifier used for sensing measurement and a measurement instance identifier used for sensing measurement.

In an embodiment, the third indication information is carried in a user information list field that corresponds to the sensing device and that is of the sensing NDPA, or carried in a special user information field, or carried in a sounding dialog token field of the sensing NDPA.

In an embodiment, the measurement setup identifier is carried in the user information list field that corresponds to the sensing device and that is of the sensing NDPA, or carried in the special user information field, or carried in the sounding dialog token field of the sensing NDPA.

In an embodiment, the measurement instance identifier is carried in the user information list field that corresponds to the sensing device and that is of the sensing NDPA, or carried in the special user information field, or carried in the sounding dialog token field of the sensing NDPA.

In an embodiment, the communication unit is further configured to:
when the initiator-to-responder null data packet I2R-NDP is an NDP used for sensing measurement, receive a sensing measurement result from the first device.

According to a seventh aspect, this application provides a communication device. The communication device may be configured to implement the method performed by the first device in the first aspect to the third aspect. The communication device includes one or more processors, a transceiver, and a memory. For example, the transceiver is coupled to the one or more processors, and the memory stores a computer program. For example, when the one or more processors and the transceiver in the communication device execute the computer program, the communication device performs the following operations:
sending a sensing sounding trigger frame to a second device, where the sensing sounding trigger frame is used to trigger the second device to send a first null data packet NDP, and the first NDP is used to perform sensing measurement;
receiving the first NDP from the second device; and
sending a second NDP to the second device, where a sensing measurement result of the second device is determined based on the second NDP.

For descriptions about the method performed by the first device, refer to corresponding descriptions in the first aspect to the third aspect. Details are not described herein again. It may be understood that the communication device may also be configured to implement effect that can be implemented by the first device in the first aspect to the third aspect.

According to an eighth aspect, this application provides a communication device. The communication device may be configured to implement the method performed by the second device in the first aspect to the third aspect. The communication device includes one or more processors, a transceiver, and a memory. For example, the transceiver is coupled to the one or more processors, and the memory stores a computer program. For example, when the one or more processors and the transceiver in the communication device execute the computer program, the communication device performs the following operations:
receiving a sensing sounding trigger frame, where the sensing sounding trigger frame is used to trigger the second device to send a first null data packet NDP, and the first NDP is used to perform sensing measurement;
sending the first NDP; and
receiving a second NDP sent by a first device, where a sensing measurement result of the second device is determined based on the second NDP.

For descriptions about the method performed by the second device, refer to corresponding descriptions in the first aspect to the third aspect. Details are not described herein again. It may be understood that the communication device may also be configured to implement effect that can be implemented by the second device in the first aspect to the third aspect.

According to a ninth aspect, this application provides a communication system. The communication system includes the first device and the second device that are described in the foregoing aspects. For example, the communication system includes devices such as a sensing access point device and a sensing non-access point device. For descriptions about functions implemented by the communication system, refer to descriptions in the first aspect to the third aspect. Details are not described herein again.

According to a tenth aspect, this application provides a computer-readable storage medium. The computer-readable storage medium stores a computer program, and the computer program is executed by a processor to implement the method in any one of the first aspect to the third aspect and the embodiments of the first aspect to the third aspect.

According to an eleventh aspect, this application provides a chip system. The chip system includes a processor, and may further include a memory, and is configured to implement the method in any one of the first aspect to the third aspect and the embodiments of the first aspect to the third aspect. The chip system may include a chip, or may include a chip and another discrete component.

According to a twelfth aspect, this application provides a computer program product including instructions. When the instructions are run on a computer, the computer is enabled to perform the method in any one of the first aspect to the third aspect and the embodiments of the first aspect to the third aspect.

According to a thirteenth aspect, an embodiment of this application provides another measurement method. The measurement method is performed by a first device. The first device may be an access point AP. The first device generates a sensing measurement setup request frame. The sensing measurement setup request frame carries first ranging indication information used to request a second device to perform ranging measurement in a sensing measurement process. The first device sends the sensing measurement setup request frame to the second device.

In an embodiment, after sending the sensing measurement setup request frame to the second device, the first device receives a sensing measurement setup response frame.

In an embodiment, the first ranging indication information is carried in a sensing measurement parameters element of the sensing measurement setup request frame.

In an embodiment, the sensing measurement setup request frame further carriers a ranging measurement parameter.

The ranging measurement parameter is carried in a ranging measurement parameters element newly added to the sensing measurement setup request frame; or
the ranging measurement parameter is carried in a ranging measurement parameters subfield newly added to the sensing measurement parameters element of the sensing measurement setup request frame.

In an embodiment, the first device sends a sensing sounding trigger frame. The sensing sounding trigger frame is used to trigger the second device to send a first null data packet NDP, and the first NDP is used to perform sensing measurement and/or ranging measurement. The first device receives the first NDP, and sends a second NDP to the second device. A sensing measurement result and/or a ranging measurement result of the second device are/is determined based on the second NDP.

In an embodiment, the second device is a sensing device.

The sensing sounding trigger frame carries a measurement setup identifier used for sensing measurement.

The measurement setup identifier is carried in a first field and/or a second field in a common information field of the sensing sounding trigger frame; or
the measurement setup identifier is carried in a user information list field of the sensing sounding trigger frame.

In an embodiment, the sensing sounding trigger frame carries a measurement instance identifier used for sensing measurement.

The measurement instance identifier is carried in the first field and/or the second field in the common information field of the sensing sounding trigger frame; or
the measurement instance identifier is carried in the user information list field of the sensing sounding trigger frame.

In an embodiment, the sensing sounding trigger frame carries first indication information, the first indication information is carried in the second field in the common information field of the sensing sounding trigger frame, and a value of the first indication information in the sensing sounding trigger frame is a first value.

In an embodiment, before sending the sensing sounding trigger frame, the first device sends a sensing polling trigger frame to the second device, and receives a first response frame for the sensing polling trigger frame from the second device. The first response frame is used to confirm that the second device participates in the sensing measurement and/or ranging measurement.

In an embodiment, the second device is a sensing device.

The sensing polling trigger frame carries a measurement setup identifier used for sensing measurement.

The measurement setup identifier is carried in a first field and/or a second field in a common information field of the sensing polling trigger frame.

In an embodiment, the sensing polling trigger frame carries a measurement instance identifier used for sensing measurement.

The measurement instance identifier is carried in the first field and/or the second field in the common information field of the sensing polling trigger frame.

In an embodiment, the sensing polling trigger frame carries first indication information, the first indication information is carried in the second field in the common information field of the sensing polling trigger frame, and a value of the first indication information in the sensing polling trigger frame is a second value.

In an embodiment, the first device sends a sensing reporting trigger frame to the second device, and the first device receives a second response frame for the sensing reporting trigger frame. The second response frame includes the sensing measurement result and/or the ranging measurement result of the second device.

In an embodiment, the second device is a sensing device.

The sensing reporting trigger frame carries a measurement setup identifier used for sensing measurement.

The measurement setup identifier is carried in a first field and/or a second field in a common information field of the sensing reporting trigger frame; or
the measurement setup identifier is carried in a user information list field of the sensing reporting trigger frame.

In an embodiment, the sensing reporting trigger frame carries a measurement instance identifier used for sensing measurement.

The measurement instance identifier is carried in the first field and/or the second field in the common information field of the sensing reporting trigger frame; or
the measurement instance identifier is carried in the user information list field of the sensing reporting trigger frame.

In an embodiment, the sensing reporting trigger frame carries first indication information, the first indication information is carried in a trigger dependent common information field of the sensing reporting trigger frame, and a value of the first indication information in the sensing reporting trigger frame is a third value.

In an embodiment, an NDPA carries one or more of the following information:
an association identifier, where the association identifier is associated with the sensing device;
second indication information, where the second indication information indicates the sensing device to perform sensing measurement and/or ranging measurement;
the measurement setup identifier used for sensing; and
the measurement instance identifier used for sensing.

In an embodiment, the second indication information is carried in a user information list field that corresponds to the sensing device and that is of the NDPA, or carried in a special user information field of the NDPA, or carried in a sounding dialog token field of the NDPA.

The measurement setup identifier is carried in the user information list field that corresponds to the sensing device and that is of the NDPA, or carried in the special user information field of the NDPA, or carried in the sounding dialog token field of the NDPA.

The measurement instance identifier is carried in the user information list field that corresponds to the sensing device and that is of the NDPA, or carried in the special user information field of the NDPA, or carried in the sounding dialog token field of the NDPA.

The association identifier is carried in the user information list field that corresponds to the sensing device and that is of the NDPA, or carried in the special user information field of the NDPA.

In an embodiment, the second device is a sensing device.

A sensing trigger frame carries the second indication information, and the sensing trigger frame is the sensing sounding trigger frame, or the sensing polling trigger frame, or the sensing reporting trigger frame.

The second indication information indicates the sensing device to perform sensing measurement and/or ranging measurement.

The second indication information is carried in a user information list field, or a first field or a second field in a common information field of the sensing trigger frame.

In an embodiment, the second response frame is a sensing report frame.

When the sensing report frame includes the sensing measurement result and the ranging measurement result, the sensing measurement result is carried in a sensing measurement report element of the sensing report frame, and the ranging measurement result is carried in a ranging measurement element newly added to the sensing report frame; or
the sensing measurement result is carried in a sensing measurement report element of the sensing report frame, and the ranging measurement result is carried in a ranging measurement report subfield newly added to the sensing measurement report element of the sensing report frame.

In an embodiment, when the second response frame includes two sensing report frames, a first sensing report frame includes the sensing measurement result, and a second sensing report frame includes the ranging measurement result, the sensing measurement result is carried in a sensing measurement report element of the first sensing report frame; and
the ranging measurement result is carried in a ranging measurement element newly added to the second sensing report frame, or carried in a ranging measurement report subfield newly added to a sensing measurement report element of the sensing report frame, or the second sensing report frame is a location measurement report LMR frame.

In the method, the AP may request the sensing device to perform ranging measurement in a sensing measurement process, to enhance a function of the sensing device. Therefore, the sensing device can complete ranging (for example, positioning) while performing sensing. In addition, sensing trigger frames such as a sensing polling trigger frame, a sensing sounding trigger frame, and a sensing reporting trigger frame are designed. In one embodiment, fields that carry information (for example, including a measurement instance identifier used for sensing measurement and a parameter used for ranging measurement) used for sensing measurement and/or ranging measurement in the type of sensing trigger frames are designed. Therefore, the type of sensing trigger frames may be used by a device with a sensing function to perform trigger-based sensing measurement and/or ranging measurement.

According to a fourteenth aspect, an embodiment of this application provides another measurement method. The measurement method is performed by a second device. The second device may be a sensing device. The second device generates a sensing measurement setup response frame in response to a sensing measurement setup request frame. The sensing measurement setup response frame carries second ranging indication information used to request a first device to perform ranging measurement in a sensing measurement process. The second device sends the sensing measurement setup response frame to the first device.

In an embodiment, before generating the sensing measurement setup response frame, the second device receives the sensing measurement setup request frame from the first device.

In an embodiment, after sending the sensing measurement setup response frame to the first device, the second device receives a sensing measurement setup confirm frame from the first device.

In an embodiment, the second ranging indication information is carried in a sensing measurement parameters element of the sensing measurement setup response frame.

In an embodiment, the sensing measurement setup response frame further carriers a ranging measurement parameter.

The ranging measurement parameter is carried in a ranging measurement parameters element newly added to the sensing measurement setup response frame; or
the ranging measurement parameter is carried in a ranging measurement parameters subfield newly added to the sensing measurement parameters element of the sensing measurement setup response frame.

In an embodiment, the second device receives a sensing sounding trigger frame. The sensing sounding trigger frame is used to trigger the second device to send a first null data packet NDP, and the first NDP is used to perform sensing measurement and/or ranging measurement. The second device sends the first NDP to the first device, and receives a null data packet announcement NDPA sent by the first device. The NDPA is used to notify the second device that the first device is to send the second NDP. The second device receives the second NDP sent by the first device. A sensing measurement result and/or a ranging measurement result of the second device are/is determined based on the second NDP.

In an embodiment, the second device is a sensing device.

The sensing sounding trigger frame carries a measurement setup identifier used for sensing measurement.

The measurement setup identifier is carried in a first field and/or a second field in a common information field of the sensing sounding trigger frame; or
the measurement setup identifier is carried in a user information list field of the sensing sounding trigger frame.

In an embodiment, the sensing sounding trigger frame carries a measurement instance identifier used for sensing measurement.

The measurement instance identifier is carried in the first field and/or the second field in the common information field of the sensing sounding trigger frame; or
the measurement instance identifier is carried in the user information list field of the sensing sounding trigger frame.

In an embodiment, the sensing sounding trigger frame carries first indication information, the first indication information is carried in the second field in the common information field of the sensing sounding trigger frame, and a value of the first indication information in the sensing sounding trigger frame is a first value.

In an embodiment, before receiving the sensing sounding trigger frame, the second device receives a sensing polling trigger frame, and sends a first response frame for the sensing polling trigger frame to the first device. The first response frame is used to confirm that the second device participates in the sensing measurement and/or the ranging measurement.

In an embodiment, the second device is a sensing device.

The sensing polling trigger frame carries a measurement setup identifier used for sensing measurement.

The measurement setup identifier is carried in a first field and/or a second field in a common information field of the sensing polling trigger frame.

In an embodiment, the sensing polling trigger frame carries a measurement instance identifier used for sensing measurement.

The measurement instance identifier is carried in the first field and/or the second field in the common information field of the sensing polling trigger frame.

In an embodiment, the sensing polling trigger frame carries first indication information, the first indication information is carried in the second field in the common information field of the sensing polling trigger frame, and a value of the first indication information in the sensing polling trigger frame is a second value.

In an embodiment, the second device receives a sensing reporting trigger frame, and sends a second response frame for the sensing reporting trigger frame to the first device. The second response frame of the sensing reporting trigger frame includes the sensing measurement result and/or the ranging measurement result of the second device.

In an embodiment, the second device is a sensing device.

The sensing reporting trigger frame carries a measurement setup identifier used for sensing measurement.

The measurement setup identifier is carried in a first field and/or a second field in a common information field of the sensing reporting trigger frame; or
the measurement setup identifier is carried in a user information list field of the sensing reporting trigger frame.

In an embodiment, the sensing reporting trigger frame carries a measurement instance identifier used for sensing measurement.

The measurement instance identifier is carried in the first field and/or the second field in the common information field of the sensing reporting trigger frame; or
the measurement instance identifier is carried in the user information list field of the sensing reporting trigger frame.

In an embodiment, the sensing reporting trigger frame carries first indication information, the first indication information is carried in a trigger dependent common information field of the sensing reporting trigger frame, and a value of the first indication information in the sensing reporting trigger frame is a third value.

In an embodiment, the NDPA carries one or more of the following information:
an association identifier, where the association identifier is associated with the sensing device;
second indication information, where the second indication information indicates the sensing device to perform sensing measurement and/or ranging measurement;
the measurement setup identifier used for sensing; and
the measurement instance identifier used for sensing.

In an embodiment, the second indication information is carried in a user information list field that corresponds to the sensing device and that is of the NDPA, or carried in a special user information field of the NDPA, or carried in a sounding dialog token field of the NDPA.

The measurement setup identifier is carried in the user information list field that corresponds to the sensing device and that is of the NDPA, or carried in the special user information field of the NDPA, or carried in the sounding dialog token field of the NDPA.

The measurement instance identifier is carried in the user information list field that corresponds to the sensing device and that is of the NDPA, or carried in the special user information field of the NDPA, or carried in the sounding dialog token field of the NDPA.

The association identifier is carried in the user information list field that corresponds to the sensing device and that is of the NDPA, or carried in the special user information field of the NDPA.

In an embodiment, the second device is a sensing device.

A sensing trigger frame carries the second indication information, and the sensing trigger frame is the sensing sounding trigger frame, or the sensing polling trigger frame, or the sensing reporting trigger frame.

The second indication information indicates the sensing device to perform sensing measurement and/or ranging measurement.

The second indication information is carried in a user information list field, or a first field or a second field in a common information field of the sensing trigger frame.

In an embodiment, the second response frame is a sensing report frame.

When the sensing report frame includes the sensing measurement result and the ranging measurement result, the sensing measurement result is carried in a sensing measurement report element of the sensing report frame, and the ranging measurement result is carried in a ranging measurement element newly added to the sensing report frame; or
the sensing measurement result is carried in a sensing measurement report element of the sensing report frame, and the ranging measurement result is carried in a ranging measurement report subfield newly added to the sensing measurement report element of the sensing report frame.

In an embodiment, when the second response frame includes two sensing report frames, a first sensing report frame includes the sensing measurement result, and a second sensing report frame includes the ranging measurement result, the sensing measurement result is carried in a sensing measurement report element of the first sensing report frame; and
the ranging measurement result is carried in a ranging measurement element newly added to the second sensing report frame, or carried in a ranging measurement report subfield newly added to a sensing measurement report element of the sensing report frame, or the second sensing report frame is a location measurement report LMR frame.

In the method, the sensing device may also request the AP to perform ranging measurement, to enhance a function of the AP. Therefore, the AP can complete ranging (for example, positioning) while performing sensing. In addition, sensing trigger frames such as a sensing polling trigger frame, a sensing sounding trigger frame, and a sensing reporting trigger frame are designed. In one embodiment, fields that carry information (for example, including a measurement instance identifier used for sensing measurement and a parameter used for ranging measurement) used for sensing measurement and/or ranging measurement in the type of sensing trigger frames are designed. Therefore, the type of sensing trigger frames may be used by a device with a sensing function to perform trigger-based sensing measurement and/or ranging measurement.

### BRIEF DESCRIPTION OF DRAWINGS

FIG. 1 is a diagram of a communication system according to an embodiment of this application;

FIG. 2a is a diagram of a sensing measurement process with a trigger-based mechanism;

FIG. 2b shows a sensing measurement scenario with a trigger-based mechanism;

FIG. 3a is a diagram of a ranging measurement process with a trigger-based mechanism;

FIG. 3b shows a ranging measurement scenario with a trigger-based mechanism;

FIG. 4a is a hybrid measurement procedure of sensing and ranging according to an embodiment of this application;

FIG. 4b is a diagram of a sensing measurement setup request frame according to an embodiment of this application;

FIG. 4c is a diagram of a sensing measurement setup response frame according to an embodiment of this application;

FIG. 4d is a diagram of a sensing measurement parameters subfield according to an embodiment of this application;

FIG. 4e is a diagram of a ranging measurement parameters subfield according to an embodiment of this application;

FIG. 4f is a diagram of a ranging measurement parameters element of a sensing measurement setup request frame according to an embodiment of this application;

FIG. 4g is a diagram of a ranging measurement parameters element of a sensing measurement setup response frame according to an embodiment of this application;

FIG. 5a is a diagram of a feedback phase of a hybrid measurement procedure of sensing and ranging according to an embodiment of this application;

FIG. 5b is a diagram of another feedback phase of a hybrid measurement procedure of sensing and ranging according to an embodiment of this application;

FIG. 5c is a diagram in which one sensing report frame is used to feed back a sensing measurement result and a ranging measurement result according to an embodiment of this application;

FIG. 5d is a diagram of a sensing report frame according to an embodiment of this application;

FIG. 5e is a diagram of a sensing measurement report element according to an embodiment of this application;

FIG. 5f is a diagram of a sensing measurement report subfield according to an embodiment of this application;

FIG. 5g is a diagram in which two sensing report frames are used to feed back a sensing measurement result and a ranging measurement result according to an embodiment of this application;

FIG. 5h is another diagram in which one sensing report frame is used to feed back a sensing measurement result and a ranging measurement result according to an embodiment of this application;

FIG. 6 is a diagram of a trigger frame;

FIG. 7 is a diagram of a common information field of a trigger frame;

FIG. 8 is a diagram of a trigger type field of a trigger frame;

FIG. 9 is a diagram of a trigger dependent common information field in a common information field of a trigger frame;

FIG. 10a is a diagram of a ranging trigger frame subtype;

FIG. 10b is a diagram of a sensing trigger subtype according to an embodiment of this application;

FIG. 10c is a diagram of an expanded trigger dependent common information field according to an embodiment of this application;

FIG. 11 is a diagram of a user information list field of a trigger frame;

FIG. 12a is a diagram of a null data packet announcement NDPA;

FIG. 12b is a diagram of another NDPA according to an embodiment of this application;

FIG. 13 is a diagram of a trigger-based measurement method according to an embodiment of this application;

FIG. 14 is a diagram of a non-trigger-based measurement method according to an embodiment of this application;

FIG. 15a is a diagram of non-trigger-based sensing measurement;

FIG. 15b is a diagram of another trigger-based measurement method according to an embodiment of this application;

FIG. 15c is a diagram of still another trigger-based measurement method according to an embodiment of this application;

FIG. 16 is a diagram of a communication device according to an embodiment of this application; and

FIG. 17 is a diagram of a communication apparatus according to an embodiment of this application.

### DESCRIPTION OF EMBODIMENTS

The following describes technical solutions in embodiments of this application with reference to the accompanying drawings in embodiments of this application.

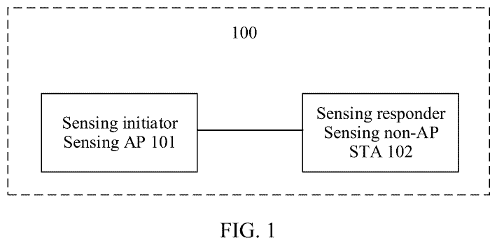

An embodiment of this application provides a measurement method based on a communication system shown in FIG. 1. In the method, a type of sensing trigger frames is designed, so that the type of sensing trigger frames can be identified by a device supporting sensing, and the device supporting sensing can have a function of trigger-based sensing measurement. A communication system 100 shown in FIG. 1 includes at least a sensing initiator (for example, an access point (AP) device) and a sensing responder (for example, a station STA) device, which is also referred to as a non-access point station (non-AP STA) device). FIG. 1 is described by using an example in which one device is a sensing AP 101 and another device is a sensing non-AP STA 102.

### I. Related Concepts in Embodiments of this Application

### 1. Communication System

In this application, the communication system may be a wireless local area network (WLAN), a cellular network, or another wireless communication system that supports a sensing procedure and/or a ranging procedure. Embodiments of this application are mainly described by using a network in which IEEE 802.11 is deployed as an example, for example, the 802.11a/b/g standard, the 802.11n standard, the 802.11ac standard, the 802.11ax standard, or a next generation of the 802.11ax standard like the 802.11be standard, Wi-Fi 7, or EHT, a next generation of the 802.11be standard, Wi-Fi 8, the 802.11bf standard, sensing, or a next-generation standard. Various aspects of this application can be expanded to other networks that use various standards or protocols, for example, Bluetooth, a high performance radio LAN (HIPERLAN) (a wireless standard that is similar to the IEEE 802.11 standard, and is mainly used in Europe), a wide area network (WAN), a personal area network (PAN), or another known or later developed network. Therefore, regardless of used coverage and a used wireless access protocol, various aspects provided in this application are applicable to any appropriate wireless network.

### 2. Access Point Device and Non-Access Point Device

In embodiments of this application, the non-AP STA has a wireless receiving and sending function, and may support the 802.11 series protocols, and communicate with an AP or another non-AP STA. For example, the non-AP STA may be any user communication device that allows a user to communicate with an AP and further communicate with a WLAN, including but not limited to, user equipment that can be connected to a network, for example, a tablet computer, a desktop computer, a laptop computer, a notebook computer, an ultra-mobile personal computer (UMPC), a handheld computer, a netbook, a personal digital assistant (PDA), or a mobile phone, an Internet of things node in the Internet of things, or a vehicle-mounted communication apparatus in the Internet of vehicles. In an embodiment, the non-AP STA may alternatively be a chip and a processing system in the foregoing terminals.

The AP in embodiments of this application is an apparatus that provides a service for the non-AP STA, and may support the 802.11 series protocols. For example, the AP may be a communication entity such as a communication server, a router, a switch, or a bridge. Alternatively, the AP may include various forms of macro base stations, micro base stations, relay stations, and the like. It is clear that the AP may alternatively be chips and processing systems in these various forms of devices, to implement the methods and functions in embodiments of this application.

### 3. Sensing Measurement

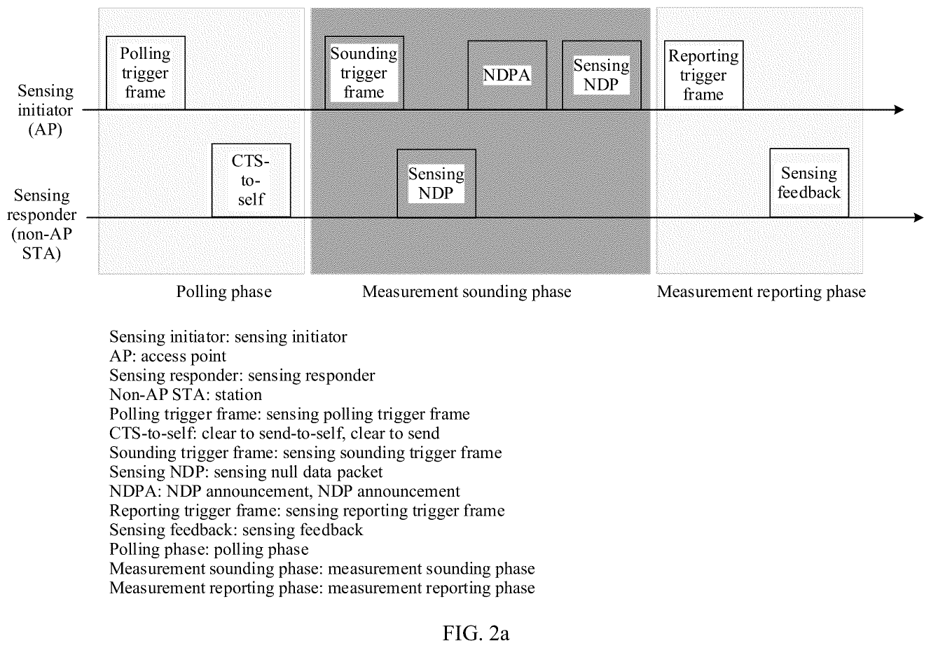

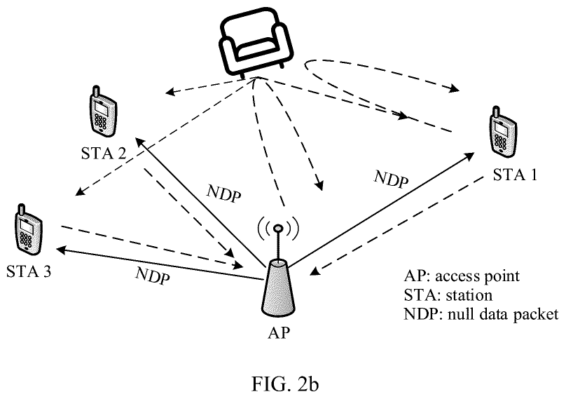

FIG. 2a shows a sensing measurement process with a trigger-based (TB) mechanism. The sensing measurement process with a trigger-based mechanism may be applied to a system scenario shown in FIG. 2b. In the sensing measurement process with a trigger-based mechanism, an AP (for example, an AP in FIG. 2b) is a sensing initiator, and a non-AP STA (for example, a STA 1 to a STA 3 in FIG. 2b) is a sensing responder. The sensing initiator is a station that initiates a sensing process, and the sensing responder (is a station that participates in the sensing process initiated by the sensing initiator. For example, the sensing measurement process with a trigger-based mechanism may include but is not limited to phases such as a polling phase, a measurement sounding phase, and a measurement reporting phase. In the polling phase, the AP may send a polling trigger frame to the non-AP STA to confirm that a polled station (non-AP STA) can participate in measurement and feedback in a current measurement entity. In the measurement sounding phase, the AP may send a sounding trigger frame to the non-AP STA to trigger the non-AP STA to transmit a sensing null data packet (sensing NDP), and to measure the transmitted sensing NDP for sensing. In an embodiment, to enhance sensing effect, the AP may further notify, via a null data packet announcement (NDPA), a corresponding non-AP STA that the AP is to send a sensing NDP immediately after sending the NDPA. The NDPA is used to notify a non-AP STA that listens to the sensing NDP of related configuration information, and the non-AP STA may measure the subsequently sent sensing NDP, to learn of channel information (for example, including channel state information (CSI)). Finally, in the measurement reporting phase, the AP may send a reporting trigger frame to the non-AP STA, so that the non-AP STA reports a measurement result to the AP in a sensing feedback manner.

### 4. Ranging Measurement

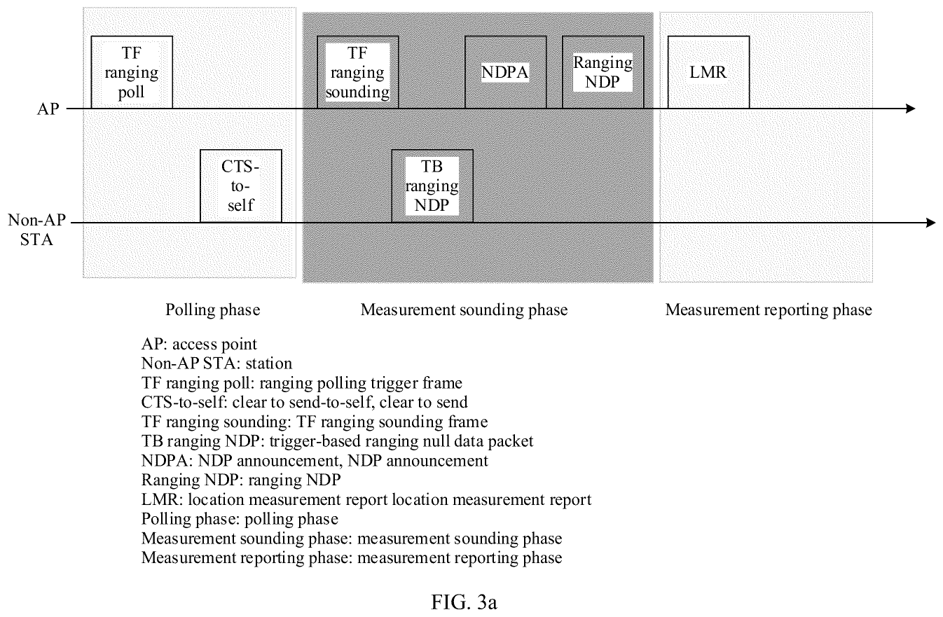

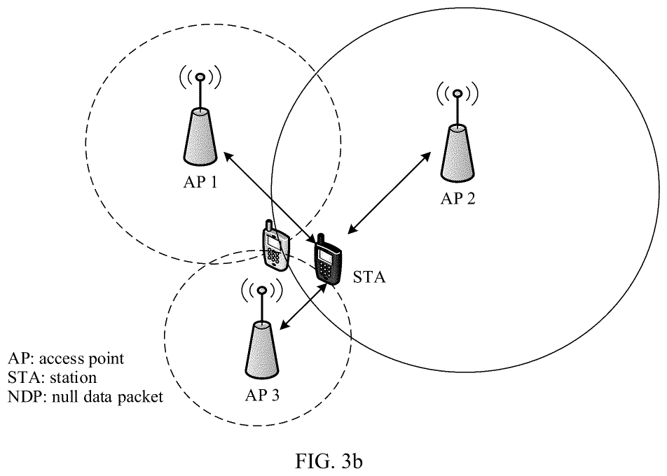

FIG. 3a shows a ranging measurement process with a trigger-based (TB) mechanism. The ranging measurement process with the trigger-based mechanism may be applied to a system scenario shown in FIG. 3b. In the ranging measurement process with the trigger-based mechanism, a non-AP STA (for example, a STA in FIG. 3b) expects to obtain a location of the non-AP STA based on a distance between the non-AP STA and an AP (for example, an AP 1 to an AP 3 in FIG. 3b). For example, the ranging measurement process with the trigger-based mechanism may include but is not limited to phases such as a polling phase, a measurement sounding phase, and a measurement reporting phase. In the polling phase, the AP may send a TF ranging poll frame to the non-AP STA to confirm that a polled station (non-AP STA) can participate in current measurement and feedback. In the measurement sounding phase, the AP may trigger, via the TF ranging sounding frame, the non-AP STA to transmit a ranging trigger NDP (TB ranging NDP). The non-AP STA may learn of sending time (t1) of the ranging trigger NDP based on the transmitted ranging trigger NDP, and correspondingly obtains time of arrival (t2) of the ranging trigger NDP when the ranging trigger NDP arrives at the AP. Then, the AP notifies, via an NDPA, the corresponding non-AP STA that the AP is to send a ranging NDP immediately after sending the NDPA. The NDPA is used to notify the non-AP STA that needs to listen to the ranging NDP of related configuration information. The ranging NDP also corresponds to sending time (t3) and time of arrival (t4). Finally, in the measurement reporting phase, the AP sends a location measurement report (LMR) frame to the non-AP STA. The LMR frame includes t2 and t3 obtained from the AP. In this case, the non-AP STA may obtain a straight line distance between the non-AP STA and the AP based on the four timestamps: t1, t2, t3, and t4, to implement ranging measurement.

### 5. Hybrid Measurement Procedure of Sensing and Ranging

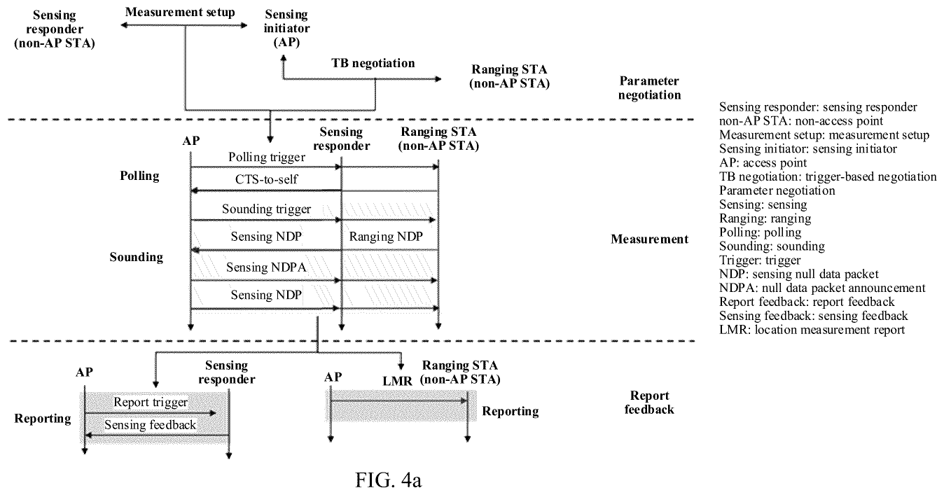

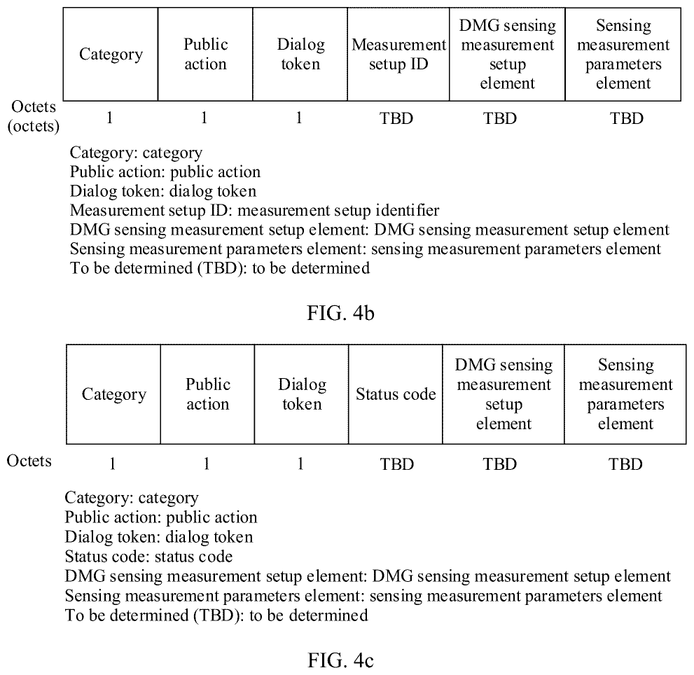

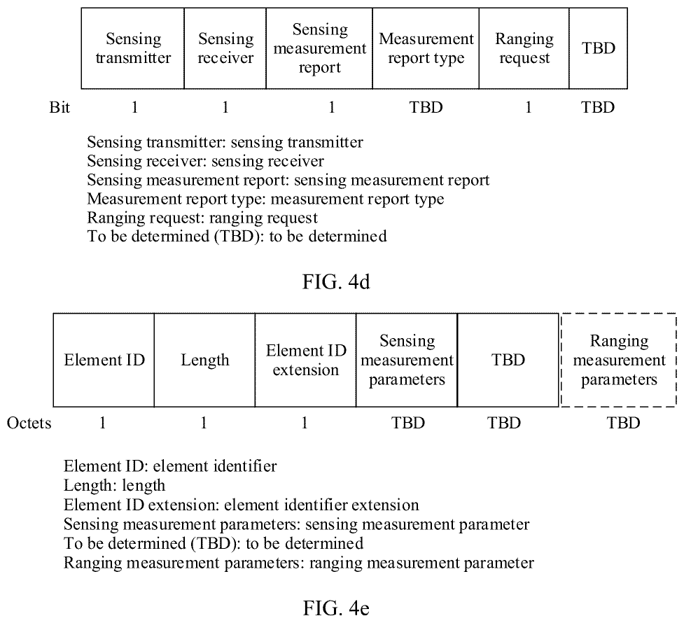

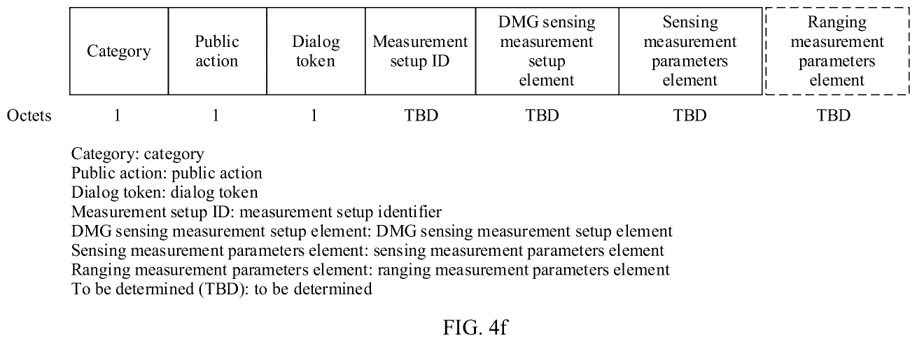

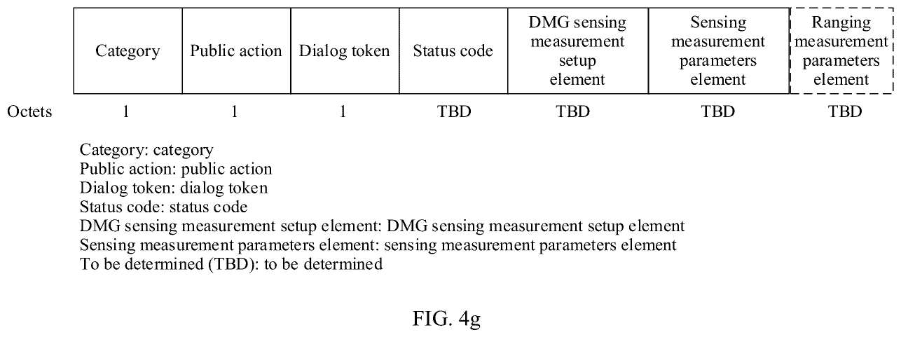

FIG. 4a is a hybrid measurement procedure of sensing and ranging according to an embodiment of this application. In the hybrid measurement procedure, an AP performs sensing measurement and/or ranging measurement with a device supporting sensing, and also performs ranging measurement with a device supporting only ranging. For example, the hybrid measurement procedure of sensing and ranging may include but is not limited to phases such as a measurement setup phase, a measurement phase, and a feedback phase. The measurement phase may include the polling phase and the measurement sounding phase described in the sensing measurement and ranging measurement processes.

Before the measurement phase, the AP separately performs parameter negotiation (namely, a negotiation phase) with the sensing device and the ranging device. In a subsequent measurement process, the sensing device and the ranging device separately use a negotiated parameter for measurement. For example, the AP shown in FIG. 4a may first negotiate with the sensing device, then negotiate with the ranging device, and start to perform the measurement process. In the measurement process, the sensing measurement and the ranging measurement described above are combined. It should be noted that, in the sensing measurement and ranging measurement processes, a trigger frame, an NDPA, and the like that are sent by the AP to a sensing non-AP STA and a ranging non-AP STA may be identified by both the sensing non-AP STA and the ranging non-AP STA. Therefore, when the AP and the sensing device perform sensing measurement, the AP and the ranging device also perform ranging measurement, to improve efficiency of the AP. In the feedback phase after the measurement process, the AP may first feed back a ranging measurement result to the ranging device, and then require the sensing device to feed back a sensing measurement result to the AP via a sensing feedback frame. It should be noted that, because the AP is a sensing initiator and expects to obtain the sensing measurement result, the non-AP STA needs to feed back the sensing measurement result to the AP. For ranging, because the non-AP STA expects to learn of a location of the non-AP STA, the AP needs to feed back the corresponding ranging measurement result to the non-AP STA, but the AP does not need the ranging measurement result. In an embodiment, the AP may not require the non-AP STA to feed back the sensing measurement result to the AP, and the non-AP STA processes the sensing measurement result. For ranging, the AP may require the non-AP STA to feed back the corresponding ranging measurement result to the AP.

It may be understood that FIG. 4a is only an implementation of a combined procedure, and the combined procedure may alternatively be implemented in another manner. For example, in the early parameter negotiation process, the AP may first perform parameter negotiation with the ranging device, and then perform parameter negotiation with the sensing device. In the final feedback phase, the AP may alternatively first trigger the sensing device to feed back the sensing measurement result, and then send the ranging measurement result to the ranging device.

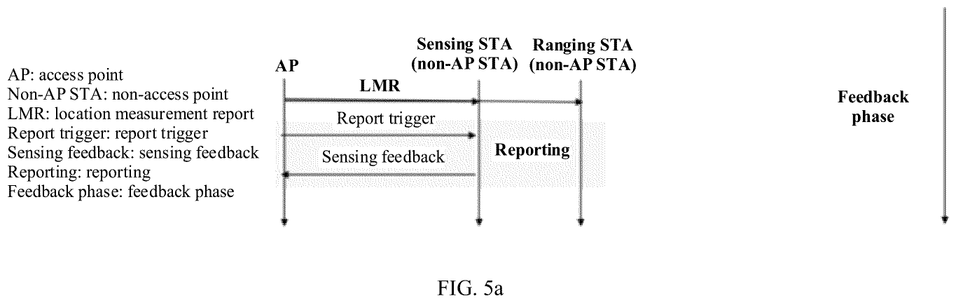

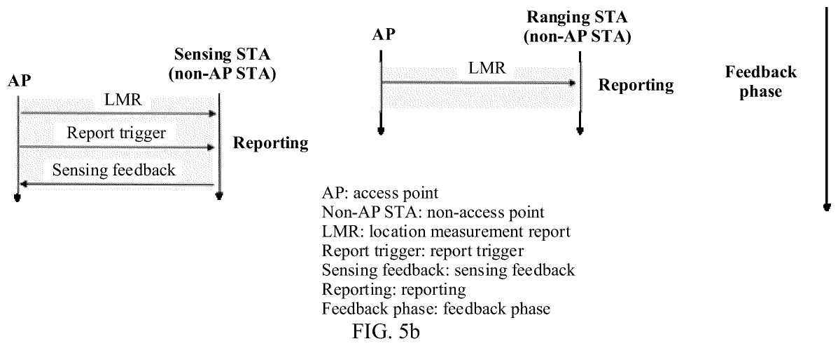

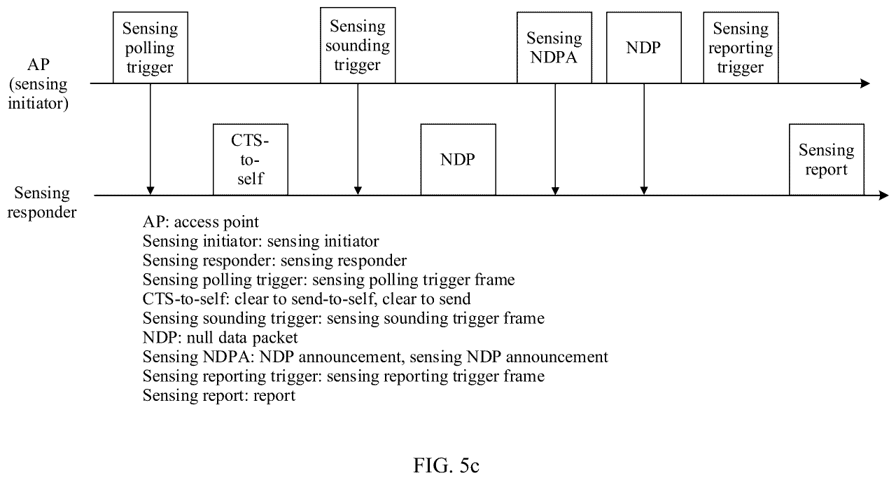

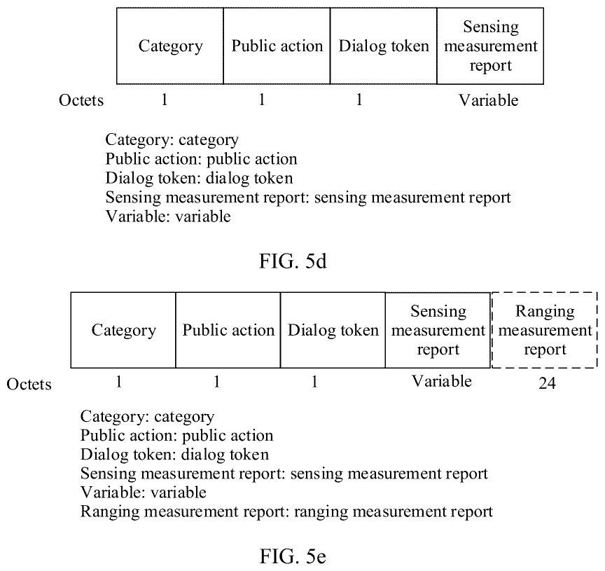

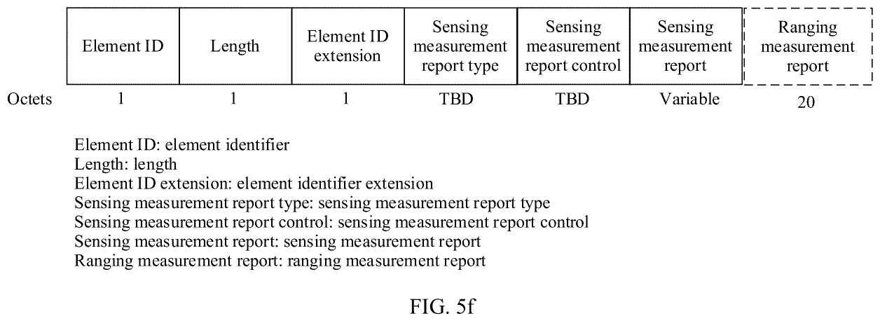

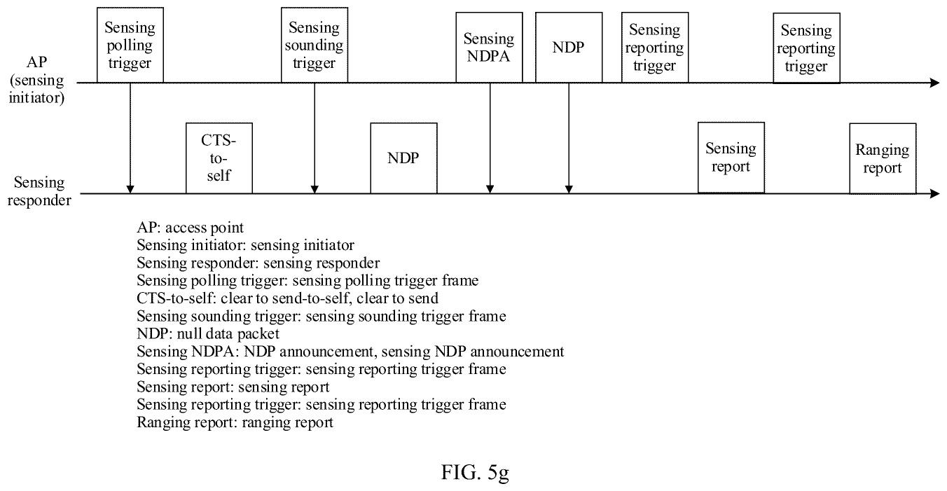

In an embodiment, if the sensing device declares to the AP that the sensing device performs both sensing and ranging in the negotiation phase, the AP also needs to feed back the ranging measurement result to the sensing device in the feedback phase. In an embodiment, the feedback phase may be shown in FIG. 5a. The AP may add the sensing measurement result of the sensing device and the ranging measurement result of the ranging device to a same LMR frame, and separately send the LMR frame to the sensing device and the ranging device. The sensing device reads the corresponding sensing measurement result, and the ranging device may also read the corresponding ranging measurement result. In another embodiment, the feedback phase may be shown in FIG. 5b. The AP may separately add the sensing measurement result of the sensing device and the ranging measurement result of the ranging device to two LMR frames, and separately send the two LMR frames to the sensing device and the ranging device. A sequence in which the AP sends the two LMR frames is not limited in embodiments of this application. For the sensing device, whether the AP first sends the ranging measurement result or first triggers the sensing measurement result is not limited in embodiments of this application.

Before the measurement phase, the AP separately performs parameter negotiation with the sensing device and the ranging device. For the sensing device, the process may also be referred to as a sensing measurement setup phase.

In an embodiment, the AP may require ranging measurement in the sensing measurement process in the sensing measurement setup phase. In this case, the AP may negotiate with the sensing device in the sensing measurement setup phase, and the negotiation process may include the following operations:

The AP sends a sensing measurement setup request frame to the non-AP STA; and
the non-AP STA sends a sensing measurement setup response frame to the AP.

In this implementation, the sensing measurement setup request frame is used by the AP and the non-AP STA for parameter negotiation, and the sensing measurement setup response frame is used to confirm a result of the parameter negotiation between the AP and the non-AP STA.

FIG. 4b shows a frame format of a sensing measurement setup request frame, including fields such as a category, a public action, a dialog token, a measurement setup identifier (measurement setup ID), a DMG sensing measurement setup element, and a sensing measurement parameters element. FIG. 4c shows a frame format of a sensing measurement setup response frame. The frame format of the sensing measurement setup response frame is similar to the frame format of the sensing measurement setup request frame, and includes fields such as a category, a public action, a sounding dialog token, a status code, a DMG sensing measurement setup element, and a sensing measurement parameters element.

When the AP requires ranging in a sensing process, the AP may add first ranging indication information to the sensing measurement setup request frame. The first ranging indication information may be specifically carried in the sensing measurement parameters element of the sensing measurement setup request frame, or may be carried in a sensing measurement parameters subfield of the sensing measurement parameters element of the sensing measurement setup request frame. The sensing measurement parameters subfield is shown in FIG. 4d. The first ranging indication information may perform indication via 1 bit. A value 0 of the 1 bit indicates that the AP does not require ranging measurement. A value 1 of the 1 bit indicates that the AP requires ranging measurement. For example, FIG. 4d shows an example in which 1 bit is used for indication, and a ranging request subfield may be newly added to the sensing measurement parameters subfield. It may be understood that a plurality of bits may be alternatively used for indication, and an indication manner is similar to the 1 bit manner. This is not limited in this application. It should be noted that when the AP requires ranging measurement, both a sensing transmitter field and a sensing receiver field in FIG. 4d need to be set to 1.

In this application, a manner in which the first ranging indication information is 1 bit is used as an example. When a value of the first ranging indication information is 1, it indicates that the AP requests ranging measurement in the sensing process, and the AP needs to add a ranging measurement parameter to the sensing measurement setup request frame shown in FIG. 4b. Manners in which the AP adds the ranging measurement parameter to the sensing measurement setup request frame may include but are not limited to the following design manners:

Manner 1: The ranging measurement parameter may be carried in a ranging measurement parameters field newly added to the sensing measurement parameters element of the sensing measurement setup request frame, as shown in FIG. 4e.

Manner 2: The ranging measurement parameter may be carried in a newly added field of the sensing measurement setup request frame. As shown in FIG. 4f, a ranging measurement parameters element is newly added to the sensing measurement setup request frame.

When the value of the first ranging indication information is 0, that is, the AP does not require ranging measurement, the sensing measurement setup request frame does not include the ranging measurement parameter described in the foregoing manner.

In another embodiment, the sensing device may require ranging in the sensing process in the sensing measurement setup phase. In this case, the sensing device may negotiate with the AP in the sensing measurement setup phase, and the negotiation process may include the following operations:

The AP sends a sensing measurement setup request frame to the non-AP STA;
the non-AP STA sends a sensing measurement setup response frame to the AP; and
the AP sends a sensing measurement setup confirm frame to the non-AP STA.

In this implementation, the sensing measurement setup request frame and the sensing measurement setup response frame are used by the AP and the non-AP STA for parameter negotiation, and the sensing measurement setup confirm frame is used to confirm a result of the parameter negotiation between the AP and the non-AP STA.

Because the sensing measurement setup request frame and the sensing measurement setup response frame have a same sensing measurement parameters element, when the sensing device requires ranging in the sensing process, the sensing device may add second ranging indication information to the sensing measurement setup response frame. The second ranging indication information may be specifically carried in the sensing measurement parameters element of the sensing measurement setup response frame, or carried in a sensing measurement parameters subfield of the sensing measurement parameters element of the sensing measurement setup response frame. The sensing measurement parameters subfield is shown in FIG. 4d. The second ranging indication information may perform indication via 1 bit. A value 0 of the 1 bit indicates that the sensing device does not require ranging measurement. A value 1 of the 1 bit indicates that the sensing device requires ranging measurement. For example, FIG. 4d shows an example in which 1 bit is used for indication, and a ranging request subfield may be newly added to the sensing measurement parameters subfield. It may be understood that a plurality of bits may be alternatively used for indication, and an indication manner is similar to the 1 bit manner. This is not limited in this application. It should be noted that when the sensing device requires ranging measurement, both the sensing transmitter field and the sensing receiver field in FIG. 4d need to be set to 1.

In this application, a manner in which the second ranging indication information is 1 bit is used as an example. When a value of the second ranging indication information is 1, it indicates that the sensing device requests ranging measurement in the sensing process, and the sensing device needs to add a ranging measurement parameter to the sensing measurement setup response frame shown in FIG. 4c. Manners in which the sensing device adds the ranging measurement parameter to the sensing measurement setup response frame may include but are not limited to the following design manners:

Manner 1: The ranging measurement parameter may be carried in a ranging measurement parameters field newly added to the sensing measurement parameters element of the sensing measurement setup response frame, as shown in FIG. 4e.

Manner 2: The ranging measurement parameter may be carried in a newly added field of the sensing measurement setup response frame. As shown in FIG. 4g, a ranging measurement parameters element is newly added to the sensing measurement setup response frame.

When the value of the second ranging indication information is 0, that is, the sensing device does not require ranging measurement, the sensing measurement setup response frame does not include the ranging measurement parameter described in the foregoing manner.

It should be noted that, in this implementation, the sensing measurement setup confirm frame is used to notify the sensing device whether the AP agrees to a ranging measurement request. If the AP agrees to the ranging measurement request, the sensing device may also be notified of information like a ranging measurement window allocated by the AP. A frame structure of the sensing measurement setup confirm frame is similar to that of the sensing measurement setup response frame. Details are not described herein again.

In another embodiment, the ranging measurement parameter negotiated in the sensing measurement setup phase may include but is not limited to information like whether to feed back a ranging measurement result, time of arrival (TOA), an angle of arrival (AOA), immediate or delayed feedback, a ranging measurement window, and an AP time synchronization counter. The ranging measurement parameters element may be included in the sensing measurement setup request frame, or may be included in the sensing measurement setup response frame. When the ranging measurement parameters element is used to carry the ranging measurement parameter, the ranging measurement parameters element may use a format shown in Table 1.

TABLE 1
Ranging measurement parameters element

| | | | Element ID | | | |
|---|---|---|---|---|---|---|
| | Element | | extension | Ranging | | Ranging |
| | ID | | (element | measurement | Ranging | measurement |
| | (element | | identifier | parameters | measurement | parameters |
| | identifier) | Length | extension) | control | parameters | subelement |
| Octets | 1 | 1 | 1 | 1 | 1 | Variable |

In one embodiment, the ranging measurement parameters control field and the ranging measurement parameters subelement are used to carry related information of the ranging measurement window. For example, the ranging measurement parameters control field shown in Table 1 may use a format shown in Table 2.

TABLE 2
Ranging measurement parameters control field

| | Partial TSF timer | | | |
|---|---|---|---|---|
| | (partial timing | | | |
| | synchronization | Availability window | | |
| | function timer) | present | Bitmap present | Reserved |
| Bit | 1 | 1 | 1 | 5 |
| (bit) | (a value 1 of the bit | (a value 1 of the bit | (a value 1 of the bit | |
| | indicates that an AP | indicates that an | indicates that a ranging | |
| | time synchronization | available ranging | measurement window | |
| | counter is included; | measurement window is | indicated by a bitmap is | |
| | or a value 0 of the | provided by the ranging | provided by the ranging | |
| | bit indicates that | measurement parameters | measurement parameters | |
| | an AP time | subelement; or a value 0 | subelement; or a value 0 | |
| | synchronization | of the bit indicates that | of the bit indicates that | |
| | counter is not | a ranging measurement | a ranging measurement | |
| | included) | window is not provided) | window indicated by a | |
| | | | bitmap is not provided) | |

When a value of availability window present in Table 2 is 1, it indicates that different windows are used for ranging measurement and sensing measurement. In this case, the ranging measurement parameters subelement in Table 1 exists, and may use a format shown in Table 3.

TABLE 3
Ranging measurement parameters subelement

| | Subelement | | | | | |
|---|---|---|---|---|---|---|
| | ID | | | | | |
| | (subelement | | | | | |
| | identifier) | Length | Count | Interval | Bitmap | Periodicity |
| Bit | 8 | 8 | 9 | 8 | Variable | 8 |
| | | | (quantity | (a ranging | (a | (measurement |
| | | | of bits in | measurement | measurement | periodicity) |
| | | | the | window is a | window for | |
| | | | bitmap) | subset of sensing | ranging | |
| | | | | measurement | measurement | |
| | | | | windows, and | is provided) | |
| | | | | ranging | | |
| | | | | measurement is | | |
| | | | | performed every | | |
| | | | | Interval windows) | | |

It may be understood that FIG. 5a is merely an example in which the AP feeds back the ranging measurement result to the sensing device and the ranging device. FIG. 5b is merely an example in which the ranging measurement result is fed back to the sensing device via the LMR frame, and the ranging measurement result is fed back to the ranging device via the LMR frame. A manner in which the AP feeds back the ranging measurement result and/or the sensing measurement result in this application is not limited. The following describes a procedure of the feedback phase in detail.

In one embodiment, when the AP needs to feed back the ranging measurement result to the sensing device, or when the sensing device needs to feed back the ranging measurement result and/or the sensing measurement result to the AP, how to feed back the ranging measurement result and/or the sensing measurement result needs to be considered.

In an embodiment, the AP may require the sensing device to feed back the ranging measurement result and/or the sensing measurement result in a sensing measurement report phase. In this case, that the AP requires the sensing device to feed back the ranging measurement result and/or the sensing measurement result may include but is not limited to the following manners:

Manner 1: The AP sends a sensing reporting trigger frame to the sensing device, to trigger the sensing device to feed back the sensing measurement result and the ranging measurement result to the AP. Correspondingly, the sensing device uses a sensing report frame (for example, the sensing report frame is a sensing report field shown in FIG. 5c) to feed back the sensing measurement result and the ranging measurement result to the AP, as shown in FIG. 5c.

The sensing reporting trigger frame may include second indication information, and the second indication information indicates the sensing device to perform sensing measurement and/or ranging measurement. A frame format of the sensing report frame may use a frame format of a sensing measurement report frame shown in FIG. 5d, and include fields such as a category, a public action, a dialog token, and a sensing measurement report. In one embodiment, that the sensing report frame carries the ranging measurement result may include the following:

For example, an element is newly added to the sensing measurement report frame shown in FIG. 5d to carry the ranging measurement result. It is assumed that a ranging measurement report element is newly added, and is specially used to carry the ranging measurement result, as shown in FIG. 5e. In this case, 1 bit in the sensing measurement report frame may indicate that the report frame includes the ranging measurement result. For example, the bit may be indicated by a ranging measurement report. As shown in Table 4, a sensing measurement report element control field may be newly added based on FIG. 5e. The sensing measurement report element control field may carry bits of the ranging measurement report, as shown in Table 5. A format of the sensing measurement report frame is shown in Table 4.

TABLE 4
Sensing measurement report frame

| | | | | Sensing | | |
|---|---|---|---|---|---|---|
| | | | | measurement | Sensing | Ranging |
| | | Public | Dialog | report element | measurement | measurement |
| | Category | action | token | control | report element | report element |
| Octet | 1 | 1 | 1 | 1 | TBD | 24 |

The sensing measurement report control field shown in Table 4 may use a format shown in Table 5.

TABLE 5
Sensing measurement report control field

| | Ranging | Immediate ranging | |
|---|---|---|---|
| | measurement report | measurement report | Reserved |
| Bit | 1 (a value 1 of the | 1 (a value 1 of the | 6 |
| | bit indicates that a | bit indicates that | |
| | ranging measurement | the result is a current | |
| | result is provided; or | measurement result; or | |
| | a value 0 of the bit | a value 0 of the bit | |
| | indicates that a ranging | indicates that the result | |
| | measurement result is | is a previous measurement | |
| | not provided) | result) | |

For another example, as shown in FIG. 5f, a ranging measurement report subfield is added to the sensing measurement report element of the sensing measurement report frame shown in FIG. 5d to carry the ranging measurement result.

Manner 2: The AP separately sends sensing reporting trigger frames to the sensing device for two times, to trigger the sensing device to feed back the sensing measurement result and the ranging measurement result to the AP. Correspondingly, the sensing device uses two sensing report frames to separately feed back the sensing measurement result and the ranging measurement result to the AP, as shown in FIG. 5g.

When one sensing reporting trigger frame is used to trigger the sensing device to feed back the sensing measurement result, the sensing reporting trigger frame may include the second indication information, and a value of the second indication information is a first value. When the other sensing reporting trigger frame is used to trigger the sensing device to feed back the ranging measurement result, the sensing reporting trigger frame may include the second indication information, and the value of the second indication information is a second value.

Similar to an embodiment of the sensing report frame in the manner 1, a frame format of the sensing report frame in the manner 2 may also use the frame format of the sensing measurement report frame shown in FIG. 5d. For example, an element is newly added to the sensing measurement report frame shown in FIG. 5d to carry the ranging measurement result. It is assumed that a ranging measurement report element is newly added, and is specially used to carry the ranging measurement result, as shown in FIG. 5e. In this case, the ranging measurement report element may use a format shown in Table 6.

TABLE 6
Ranging measurement report element

| | | | Element ID | | |
|---|---|---|---|---|---|
| | | | extension | Ranging | |
| | Element ID | | (element | measurement | Ranging |
| | (element | | identifier | report | measurement |
| | identifier) | Length | extension) | control | report |
| Octet | 1 | 1 | 1 | 1 | 20 |

The ranging measurement report control field shown in Table 6 may use a format shown in Table 7.

TABLE 7
Ranging measurement report control

| | | Sensing | Sensing | | |
|---|---|---|---|---|---|
| | | measurement | measurement | | |
| | Ranging | setup ID | instance ID | | |
| | setup ID | (sensing | (sensing | Immediate | |
| | (ranging | measurement | measurement | ranging | |
| | setup | setup | instance | measurement | |
| | identifier) | identifier) | identifier) | report | Reserved |
| Bit | 1 | 1 | 1 | 1 | 4 |

The ranging measurement report control field shown in Table 6 may use a format shown in Table 8.

TABLE 8
Ranging measurement report

| | | Sensing | Sensing | | | | | |
|---|---|---|---|---|---|---|---|---|
| | | measurement | measurement | | | | | |
| | Ranging | setup ID | instance ID | | | | TOA | TOD |
| | setup ID | (sensing | (sensing | | | | error | error |
| | (ranging | measurement | measurement | TOA | TOD | AOA | (error of | (error of |
| | setup | setup | instance | (time of | (time of | (angle of | time of | time of |
| | identifier) | identifier) | identifier) | arrival) | departure) | arrival) | arrival) | departure) |
| Bit | 4 | 4 | 8 | 48 | 48 | 16 | 8 | 8 |
| | CFO | | | | | | | |
| | parameters | | | | | | | |
| | (carrier | | | | | | | |
| | frequency | | | | | | | |
| | offset | | | | | | | |
| | parameters) | | | | | | | |
| Bit | 16 | | | | | | | |

It should be noted that the sensing measurement setup identifier and the measurement instance identifier in Table 7 and Table 8 indicate which time of sensing measurement is used to obtain the ranging measurement result.

For another example, as shown in FIG. 5f, a ranging measurement report subfield is added to the sensing measurement report element of the sensing report frame to carry the ranging measurement result.

In another embodiment, the sensing device may require the AP to feed back the ranging measurement result in the sensing measurement report phase. The following operations are included:

The AP sends a ranging report frame to the sensing device, where the ranging report frame includes the ranging measurement result obtained from the AP. The AP may further send a sensing reporting trigger frame to the sensing device, to trigger the sensing device to feed back the sensing measurement result to the AP. Correspondingly, the sensing device uses a sensing report frame to feed back the sensing measurement result to the AP, as shown in FIG. 5h. The report frame of the ranging measurement result may use the format similar to that in FIG. 5b, Table 4 to Table 8, or the LMR frame. This is not limited in this application. It should be noted that, if a sensing service requires the sensing device to feed back the sensing result to the AP, a process in which the AP feeds back the ranging measurement result may occur before or after the sensing result is fed back. This is not limited in this application.

It may be understood that names of some frames described in FIG. 2a to FIG. 5h may be different, but represent same frames. For example, the polling trigger in FIG. 4a may also be referred to as sensing polling trigger, the sounding trigger in FIG. 4a may also be referred to as sensing sounding trigger, the report trigger in FIG. 4a may also be referred to as sensing reporting trigger, and the sensing feedback in FIG. 2a or FIG. 4a may also be referred to as a sensing report.

### 6. Trigger Frame

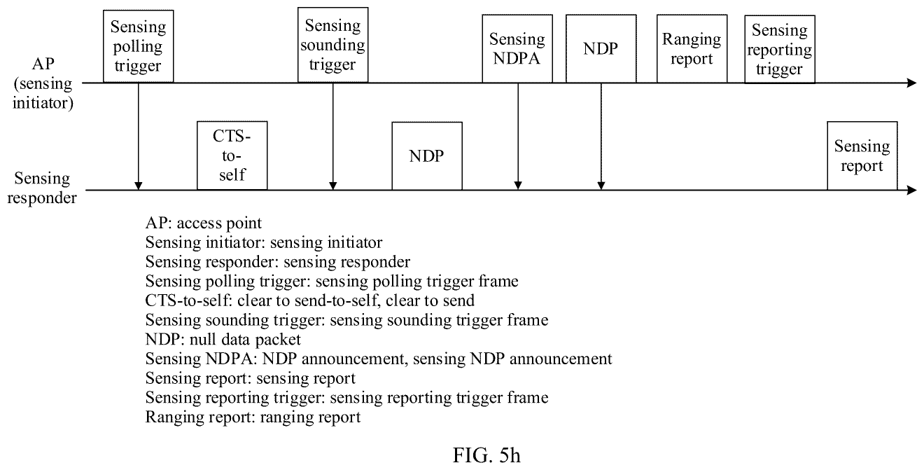

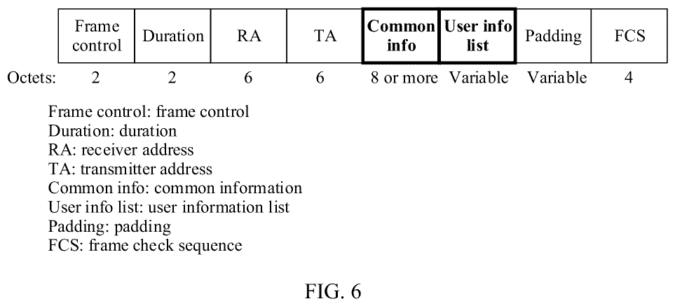

FIG. 6 shows a standard trigger frame. A TF ranging poll frame, a TF ranging sounding frame, and a ranging reporting trigger frame that are used in ranging measurement are all designed based on a format of the trigger frame. In embodiments of this application, a sensing polling trigger frame, a sensing sounding trigger frame, and a sensing reporting trigger frame that are used in sensing measurement are designed based on the trigger frame shown in FIG. 6. A common information (common info) field and a user information list (user info list) field in the standard trigger frame shown in FIG. 6 are mainly improved, to implement the designs in embodiments of this application. It may be understood that a definition of another field (for example, a field that is not described in detail in embodiments of this application, for example, a frame control field) shown in FIG. 6 is similar to a definition in an existing protocol. This is not limited in embodiments.

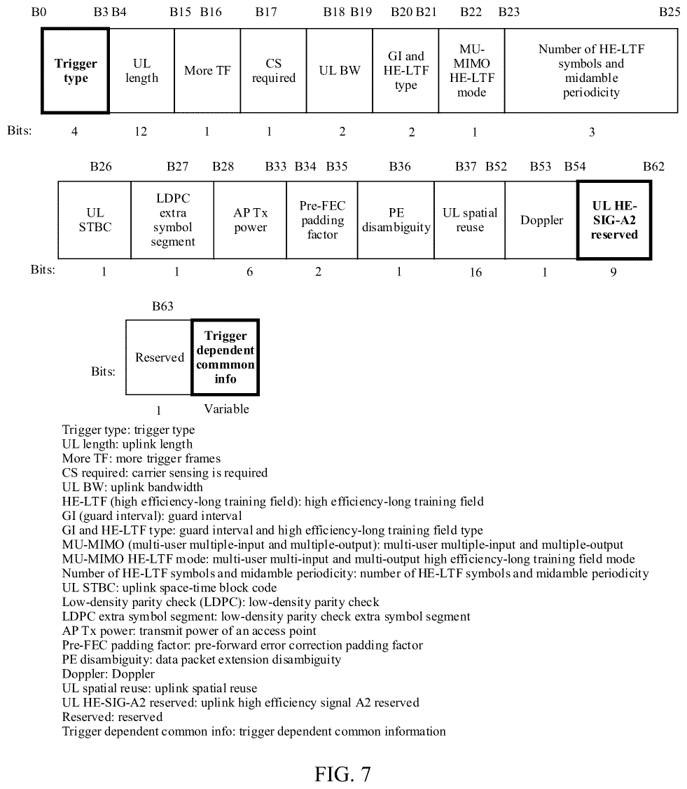

(1) Common information (common info) field: A format of the common information field is shown in FIG. 7. Common information fields of the TF ranging poll frame, the TF ranging sounding frame, and the ranging reporting trigger frame that are used in ranging measurement each include at least 64 bits of B0 to B63, that is, 8 bytes. Similarly, common information fields of the sensing polling trigger frame, the sensing sounding trigger frame, and the sensing reporting trigger frame that are designed in embodiments of this application each include at least 64 bits. It may be understood that a definition of another field (for example, a field that is not described in detail in embodiments of this application, for example, an uplink length (UL length)) shown in FIG. 7 is similar to a definition in the existing protocol. This is not limited in embodiments.

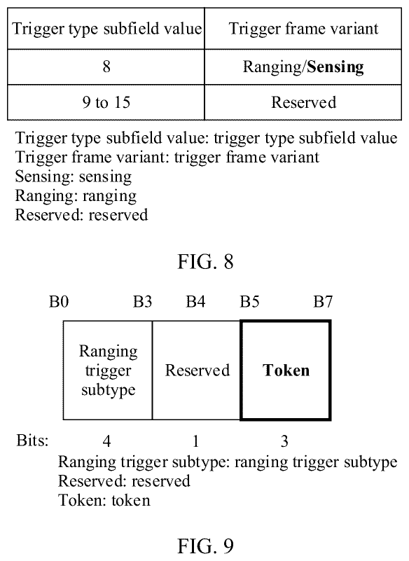

A. Trigger type field: In the common information field shown in FIG. 7, 4 bits of B0 to B3 belong to the trigger type field, and the field indicates a type of the trigger frame. The 4 bits may indicate 16 values, and each value indicates a type. In the existing protocol, a value 8 of the trigger type field indicates that the trigger frame is a ranging trigger frame, and the ranging device may identify the value and use the trigger frame for ranging measurement, as shown in FIG. 8. In embodiments of this application, a same value, namely, 8, indicates that the trigger frame is a sensing trigger frame. In other words, in embodiments of this application, when the value of the trigger type field of the trigger frame is 8, the ranging device may identify the trigger frame as the ranging trigger frame, and the sensing device may identify the trigger frame as the sensing trigger frame. This helps implementation of a hybrid measurement procedure.

B. Trigger dependent common information (trigger dependent common info) field: In the common information field shown in FIG. 7, a variable field after B63 is a trigger dependent common information field, and is used to carry information about the type of trigger frame. In embodiments of this application, the trigger dependent common information field is also referred to as a second field in the common information field. For example, a format of a trigger dependent common information field in an existing ranging trigger frame is shown in FIG. 9, and includes 8 bits (1 byte) in total. For the existing ranging trigger frame, information about the ranging trigger frame may be carried in a token domain of the trigger dependent common information field. In the sensing trigger frame designed in embodiments of this application, information (for example, it is assumed that the information is 1 bit, and is the second indication information described in the following embodiments) about the sensing trigger frame may be carried in B4 of the trigger dependent common information field.

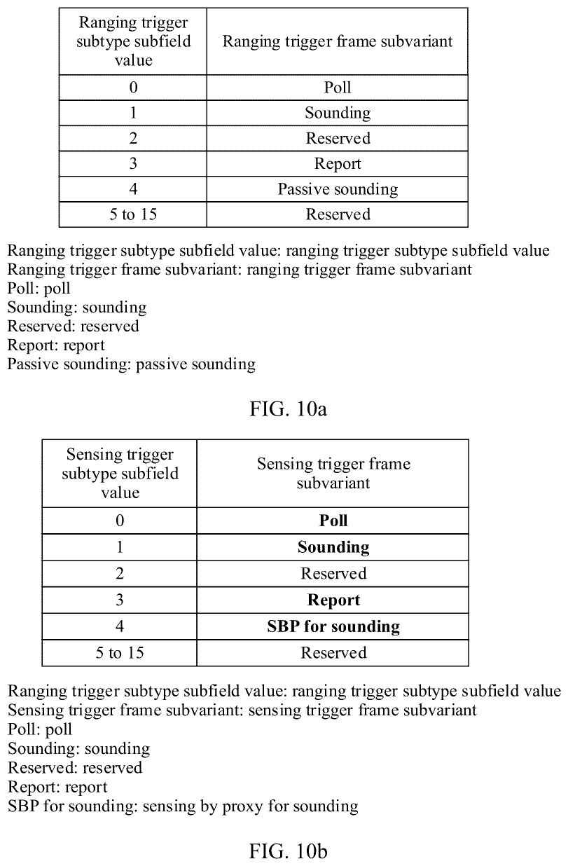

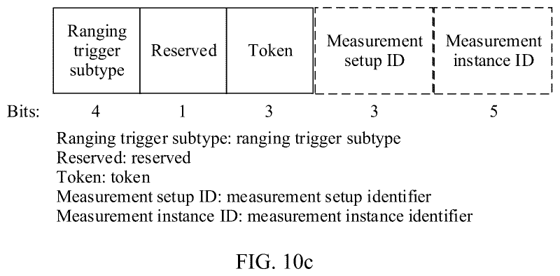

In the trigger dependent common information field shown in FIG. 9, B0 to B3 indicate a ranging trigger frame subtype, that is, B0 to B3 indicate first indication information described in the following embodiments, where 4 bits of B0 to B3 may indicate 16 subtypes, and information is shown in FIG. 10a. For example, when the trigger frame is a polling trigger frame, a value indicated by B0 to B3 is 0. When the trigger frame is a sounding trigger frame, a value indicated by B0 to B3 is 1. In embodiments of this application, a sensing trigger subtype is designed with reference to FIG. 10a, and information is shown in FIG. 10b. In FIG. 10b, when the sensing trigger frame is a sensing polling trigger frame, a value indicated by B0 to B3 is 0. When the sensing trigger frame is a sensing sounding trigger frame, a value indicated by B0 to B3 is 1. In an embodiment, if the AP does not support sensing by proxy (SBP), a value 4 is a reserved value. The trigger dependent common information field shown in FIG. 9 further includes a 1-bit reserved field. It should be noted that SBP for sounding in this application may also be referred to as sounding for SBP.

In an embodiment, in this application, the trigger dependent common information field shown in FIG. 9 may be further expanded. For example, a trigger dependent common info field in FIG. 6 is used to extend the trigger dependent common information field to 2 bytes that are respectively used to carry a measurement setup identifier (measurement setup ID) used for sensing measurement and a measurement instance identifier (measurement instance ID) used for sensing measurement described in the following embodiments, as shown in FIG. 10c.

C. Uplink high efficiency signal A2 reserved (UL HE-SIG-A2 reserved) field: In the common information field shown in FIG. 7, B54 to B63 are reserved fields. In other words, for the existing ranging trigger frame, B54 to B63 do not carry information about the ranging trigger frame, and the ranging device may not need to read information in the reserved fields. In embodiments of this application, the UL HE-SIG-A2 reserved field (including B54 to B62) and one reserved bit (B63) are also referred to as a first field in the common information field. In the sensing trigger frame designed in embodiments of this application, information (for example, it is assumed that the information is 1 bit, and is the second indication information described in the following embodiments) about the sensing trigger frame may be carried in B63. In addition, information (for example, the measurement setup identifier (measurement setup ID) used for sensing measurement and the measurement instance identifier (measurement instance ID) used for sensing measurement that are described in the following embodiments) used for sensing measurement may be carried in B54 to B62.

(2) User information list (user info list) field: A format of the user information list field is shown in FIG. 11. User information list fields of the TF ranging poll frame, the TF ranging sounding frame, and the ranging reporting trigger frame that are used in ranging measurement each include at least 40 bits of B0 to B39. Similarly, common information fields of the sensing polling trigger frame, the sensing sounding trigger frame, and the sensing reporting trigger frame that are designed in embodiments of this application each include at least B0 to B39. In the sensing trigger frame designed in embodiments of this application, information (for example, it is assumed that the information is 1 bit, and is the second indication information described in the following embodiments) about the sensing trigger frame may be carried in a 1-bit reserved field (B39) or a 2-bit reserved field (B24 and B25) of the user information list field. For example, information (for example, the measurement setup identifier (measurement setup ID) used for sensing measurement and the measurement instance identifier (measurement instance ID) used for sensing measurement that are described in the following embodiments) used for sensing measurement may be carried in B12 to B20 of the user information list field of the sensing sounding trigger frame. It may be understood that a definition of another field (for example, a field that is not described in detail in embodiments of this application, for example, uplink target receive power (UL target receive power)) shown in FIG. 11 is similar to a definition in the existing protocol. This is not limited in embodiments.

### 7. NDPA

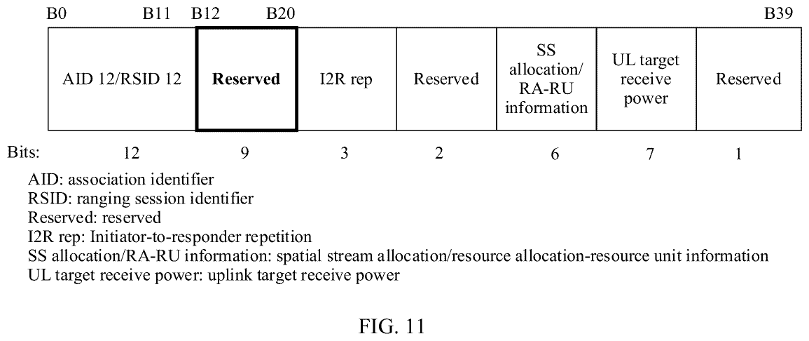

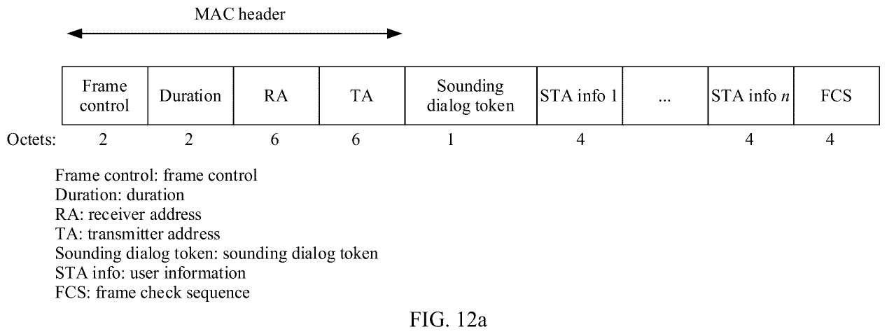

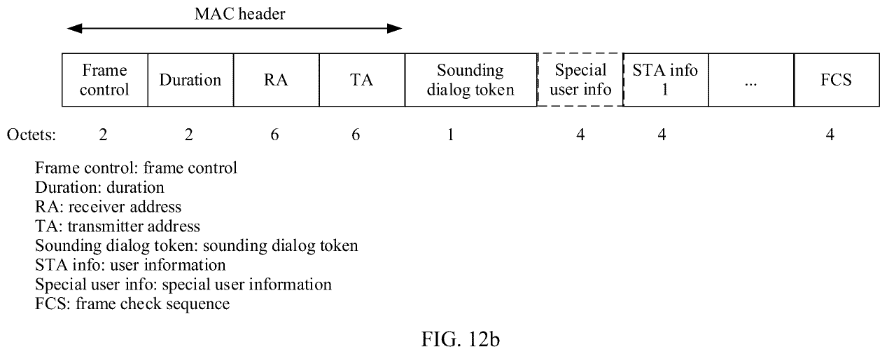

FIG. 12a shows a frame format of an HE NDPA, including a sounding dialog token field, a plurality of user information list fields, and the like. In the 802.11az standard protocol, a ranging NDPA is designed based on the HE NDPA in FIG. 12a. In embodiments of this application, a sensing NDPA is also designed based on FIG. 12a. Design manners of the sensing NDPA in embodiments of this application may include but are not limited to the following several design manners:

Manner 1: The AP adds information, for example, the measurement setup identifier (measurement setup ID) used for sensing measurement and the measurement instance identifier (measurement instance ID) used for sensing measurement that are described in the following embodiments, used for sensing measurement to a user information list (STA info) field of a corresponding sensing device, and adds information about ranging measurement to a user information list field of a corresponding ranging device. Each user information list field includes an association identifier (AID), and each device may determine, based on the AID, whether the field is sent to the device.

Manner 2: The AP may newly add a special user information (special user info) field to the NDPA, as shown in FIG. 12b. For example, the measurement setup identifier (measurement setup ID) used for sensing measurement and the measurement instance identifier (measurement instance ID) used for sensing measurement that are described in the following embodiments are carried in the special user information field, and the information about ranging measurement is still carried in the user information list field of the corresponding ranging device.

Manner 3: The AP may add the measurement setup identifier (measurement setup ID) used for sensing measurement and the measurement instance identifier (measurement instance ID) used for sensing measurement that are described in the following embodiments to the sounding dialog token field. The ranging device uses the sounding dialog token field as a sounding dialog token field of the ranging device.

After sending the sensing NDPA, the AP immediately sends an NDP. The sensing device performs sensing measurement based on the received NDP, and the ranging device performs ranging measurement based on the received NDP. It may be understood that a definition of another field (for example, a field that is not described in detail in embodiments of this application, for example, frame control) shown in FIG. 11 is similar to a definition in the existing protocol. This is not limited in embodiments.

II. Trigger-Based Measurement Method (a Sensing Measurement Scenario Including a Sensing Device) Provided in Embodiments of this Application

### 1. Measurement Sounding Phase

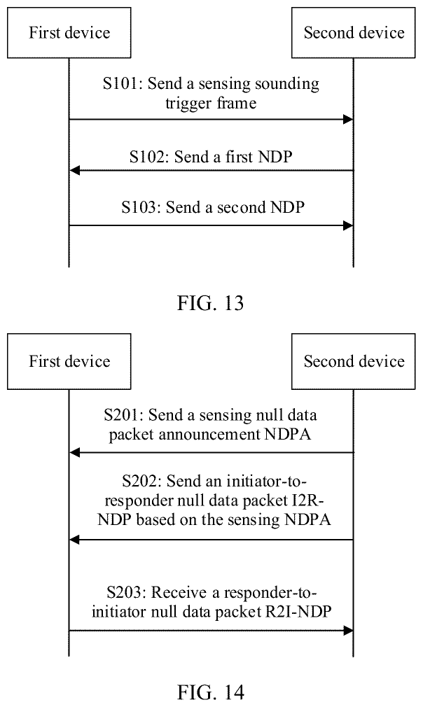

FIG. 13 is a schematic flowchart of a trigger-based measurement method according to this application. The measurement method is implemented through interaction between a first device and a second device, and includes the following operations:

S101: The first device sends a sensing sounding trigger frame to the second device.

S102: The second device sends a first NDP to the first device.

In this embodiment, the first device is a sensing AP, and the second device is a sensing non-AP STA. In other words, the second device is a sensing device.

The sensing sounding trigger frame is used to trigger the second device to send the first null data packet NDP. The first NDP is used for sensing measurement. For example, in the sensing procedure shown in FIG. 2a, the AP may send a sensing sounding trigger frame to the sensing non-AP STA (namely, a sensing device). Correspondingly, the sensing device receives the sensing sounding trigger frame, and performs a corresponding sensing measurement procedure.

For example, for the sensing device, the sensing sounding trigger frame is used to trigger the second device to send a sensing NDP used for sensing measurement to the first device. In other words, the first NDP is the sensing NDP. It may be understood that the first NDP is the sensing NDP sent by the second device (for example, the sensing non-AP STA) to the first device (for example, the sensing AP), and the AP may measure the first NDP, to obtain CSI of a channel from the non-AP STA to the AP. In other words, the first NDP is used for sensing measurement.

In an embodiment, the sensing sounding trigger frame carries first indication information, the first indication information is carried in a second field in a common information field of the sensing sounding trigger frame, and a value of the first indication information in the sensing sounding trigger frame is a first value. It may be understood that the first indication information is indication information indicating a sensing trigger subtype, and is carried in a trigger dependent common information field. For example, a value of the first indication information in the sensing sounding trigger frame is 2 (that is, the first value is 2). When receiving the trigger frame, the second device may identify the trigger frame as a sensing sounding trigger frame.

In an embodiment, the sensing sounding trigger frame carries a measurement setup identifier (measurement setup ID) used for sensing measurement and a measurement instance identifier (measurement instance ID) used for sensing measurement. In embodiments of this application, lengths (namely, occupied bits) of the measurement setup ID and the measurement instance ID are not limited. For example, it is assumed that the length of the measurement setup ID is 3 bits, and the length of the measurement instance ID is 5 bits.

In this embodiment, the second device is the sensing device, that is, the trigger-based sensing measurement procedure shown in FIG. 2a is performed between the first device and the second device. Because there is no ranging device, the sensing sounding trigger frame may not need to be compatible with a ranging device. In the sensing sounding trigger frame in this embodiment, manners in which the information is carried in the sensing sounding trigger frame may include but are not limited to the following manners:

Manner 1: The measurement setup identifier is carried in a first field and/or the second field in the common information field of the sensing sounding trigger frame, or carried in a user information list field of the sensing sounding trigger frame.

For example, the measurement setup ID may be carried in the trigger dependent common information field (as shown in FIG. 9, for example, B5 to B7 in FIG. 9) of the sensing sounding trigger frame, or may be carried in the first field (as shown in FIG. 7, for example, B54 to B62 in FIG. 7) in the common information field of the sensing sounding trigger frame, or may be carried in the user information list field (as shown in FIG. 11, for example, B12 to B20 in FIG. 11) of the sensing sounding trigger frame. In addition, a length of the trigger dependent common information field in the manner 1 is less than or equal to 8 bits, that is, a length of the sensing sounding trigger frame is the same as a length of a TF ranging sounding frame, and the length of the trigger dependent common information field is not expanded. This helps avoid a case in which the ranging device cannot identify the sensing sounding trigger frame because the length of the sensing sounding trigger frame is expanded.

In an embodiment, when the length of the measurement setup identifier is long, the measurement setup identifier may alternatively be carried in both the first field and the second field. For example, it is assumed that the length of the measurement setup ID is 5 bits, where 3 bits are carried in the trigger dependent common information field (for example, B5 to B7 in FIG. 9) of the sensing sounding trigger frame, and the other 2 bits are carried in the first field (for example, B54 and B55 in B54 to B62 in FIG. 7) in the common information field of the sensing sounding trigger frame.

Manner 2: The measurement instance identifier is carried in the first field and/or the second field in the common information field of the sensing sounding trigger frame, or carried in the user information list field of the sensing sounding trigger frame.

For example, the measurement instance ID may be carried in the trigger dependent common information field (as shown in FIG. 9, for example, B5 to B7 in FIG. 9) of the sensing sounding trigger frame, or may be carried in the common information field (as shown in FIG. 7, for example, B54 to B62 in FIG. 7) of the sensing sounding trigger frame, or may be carried in the user information list field (as shown in FIG. 11, for example, B12 to B20 in FIG. 11) of the sensing sounding trigger frame. In addition, the length of the trigger dependent common information field in the manner 2 is less than or equal to 8 bits, that is, the length of the sensing sounding trigger frame is the same as the length of the TF ranging sounding frame, and the length of the trigger dependent common information field is not expanded. This helps avoid a case in which the ranging device cannot normally identify the sensing sounding trigger frame because the length of the sensing sounding trigger frame is expanded.

In an embodiment, when the length of the measurement instance identifier is long, the measurement instance identifier may alternatively be carried in both the first field and the second field. For example, it is assumed that the length of the measurement instance ID is 5 bits, where 3 bits are carried in the trigger dependent common information field (for example, B5 to B7 in FIG. 9) of the sensing sounding trigger frame, and the other 2 bits are carried in the first field (for example, B54 and B55 in B54 to B62 in FIG. 7) in the common information field of the sensing sounding trigger frame.

Manner 3: Both the measurement setup identifier and the measurement instance identifier are carried in the second field in the common information field of the sensing sounding trigger frame.

For example, the trigger dependent common information field is expanded from less than or equal to 8 bits to greater than or equal to 8 bits in the manner 3. In this case, both the measurement setup ID and the measurement instance ID may be carried in the trigger dependent common information field of the sensing sounding trigger frame.

S103: The first device sends a second NDP to the second device.

A sensing measurement result of the second device is determined based on the second NDP. For example, the second NDP is a sensing NDP sent by the first device (for example, the sensing AP) to the second device (for example, the sensing non-AP STA). In this case, the non-AP STA may measure the second NDP, to obtain CSI of a channel from the AP to the non-AP STA, that is, determining the sensing measurement result of the second device based on the second NDP.

In an embodiment, before the first device sends the second NDP to the second device, the following operation is further included:

The first device sends a null data packet announcement NDPA to the second device, where the NDPA is used to notify the second device that the first device is to send the second NDP.

For example, in the sensing measurement process shown in FIG. 2a, the AP (first device) may send the NDPA to the sensing non-AP STA (second device). Correspondingly, the second device receives the NDPA, where the NDPA is a sensing NDPA for the sensing device. The sensing NDPA is used to notify the second device that the first device is to send the sensing NDP used for sensing measurement.

In an embodiment, the NDPA carries one or more of the following information:
an association identifier, where the association identifier is associated with the sensing device;
second indication information, where the second indication information indicates the sensing device to perform sensing measurement;
the measurement setup identifier used for sensing measurement; and
the measurement instance identifier used for sensing measurement.

For example, the NDPA in this embodiment is a sensing NDPA, and manners in which the NDPA carries the information may include but are not limited to the following several manners:

Manner 1: The second indication information is carried in a user information list field that corresponds to the sensing device and that is of the NDPA, or carried in a special user information field of the NDPA, or carried in a sounding dialog token field of the NDPA. The second indication information is indication information newly added in embodiments of this application. For a description, refer to descriptions about the second indication information in 4 in the following.

Manner 2: The measurement setup identifier is carried in the user information list field that corresponds to the sensing device and that is of the NDPA, or carried in the special user information field of the NDPA, or carried in the sounding dialog token field of the NDPA. For example, the NDPA may use the frame format of the HE NDPA shown in FIG. 12a, a user information list field (for example, a user information list field 1) of the NDPA is set to the user information list field of the corresponding sensing device, and the measurement setup ID may be carried in the user information list field 1. For another example, the NDPA may use the frame format of the HE NDPA shown in FIG. 12a, a special user information field is newly added between the sounding dialog token field and the user information field. In this case, the measurement setup ID may be carried in the newly added special user information field. For another example, the NDPA may use the frame format of the HE NDPA shown in FIG. 12a, and the measurement setup ID may be carried in the sounding dialog token field. For the sensing device, the sensing device identifies that the sounding dialog token field carries the measurement setup ID.

Manner 3: The measurement instance identifier is carried in the user information list field that corresponds to the sensing device and that is of the NDPA, or carried in the special user information field of the NDPA, or carried in the sounding dialog token field of the NDPA. For an example of the measurement instance ID, refer to the example of the measurement setup ID in the manner 2. Details are not described herein again.

Manner 4: The association identifier is carried in the user information list field that corresponds to the sensing device and that is of the NDPA, or carried in the special user information field of the NDPA. The user information list field or the special user information field further includes the association identifier (AID), and the association identifier is associated with the sensing device. For example, the AID of the user information list field is associated with the sensing device corresponding to the user information list field (for example, the AID is an ID of the corresponding sensing device). For another example, the AID of the special user information field may be associated with the sensing device. The AID herein is not an ID of a sensing device, but may be a special value that may be read by the sensing device.

It can be learned that in a measurement sounding phase in the sensing measurement scenario and the hybrid measurement scenario described in the foregoing embodiments, the first device (AP) may simultaneously perform sensing measurement and/or ranging measurement with the sensing device and the ranging device, to improve efficiency of the AP. In addition, the sensing device may complete sensing measurement, or ranging measurement, or sensing measurement and ranging measurement. This adds a ranging function to the sensing device, and enriches functions of the sensing device. In addition, the ranging device may transparently participate in the sensing procedure, to complete ranging, and the AP does not need to additionally initiate a ranging procedure.

### 2. Polling Phase in the Sensing Measurement Scenario and the Hybrid Measurement Scenario

Based on the descriptions about the embodiment in FIG. 2a, before sending the sensing sounding trigger frame, the first device may further send a sensing polling trigger frame to the second device. Therefore, the second device feeds back a first response frame for the sensing polling trigger frame, to confirm whether the second device participates in the sensing measurement process. For example, before S101 shown in FIG. 13, the following operations may be further included:

S11: The first device sends the sensing polling trigger frame to the second device.

S12: The first device receives the first response frame for the sensing polling trigger frame from the second device, where the first response frame is used to confirm that the second device participates in the sensing measurement.

In other words, after the AP sends the sensing polling trigger frame to the sensing device, if the sensing device confirms to participate in sensing measurement, the sensing device may send the first response frame (for example, a CTS-to-self frame) to the AP, to notify the AP that the sensing device confirms to participate in sensing measurement.

In an embodiment, the sensing polling trigger frame carries first indication information, the first indication information is carried in a second field in a common information field of the sensing polling trigger frame, and a value of the first indication information in the sensing polling trigger frame is a second value. It may be understood that the first indication information is indication information indicating a sensing trigger subtype, and is carried in a trigger dependent common information field. For example, the value of the first indication information in the sensing polling trigger frame is 1 (that is, the second value is 1). When receiving the trigger frame, the second device may identify the trigger frame as a sensing polling trigger frame.

In an embodiment, the sensing polling trigger frame carries a measurement setup identifier (measurement setup ID) used for sensing measurement and a measurement instance identifier (measurement instance ID) used for sensing measurement. It may be understood that because there is no ranging device, the sensing polling trigger frame may not need to be compatible with the ranging device. In the sensing polling trigger frame, manners in which the information is carried in the sensing polling trigger frame may include but are not limited to the following manners:

Manner 1: The measurement setup identifier is carried in a first field and/or the second field in the common information field of the sensing polling trigger frame. For example, the measurement setup ID may be carried in a token domain (as shown in FIG. 9, for example, B5 to B7 in FIG. 9) of the trigger dependent common information field of the sensing polling trigger frame, or may be carried in the common information field (as shown in FIG. 7, for example, B54 to B62 in FIG. 7) of the sensing polling trigger frame.

In an embodiment, when a length of the measurement setup identifier is long, the measurement setup identifier may alternatively be carried in both the first field and the second field. For examples, refer to corresponding descriptions in the foregoing embodiments. Details are not described herein again.

Manner 2: The measurement instance identifier is carried in the first field or the second field in the common information field of the sensing polling trigger frame. For example, the measurement instance ID may be carried in the token domain (as shown in FIG. 9, for example, B5 to B7 in FIG. 9) of the trigger dependent common information field of the sensing polling trigger frame, or may be carried in the common information field (as shown in FIG. 7, for example, B54 to B62 in FIG. 7) of the sensing polling trigger frame.

In an embodiment, when a length of the measurement instance identifier is long, the measurement instance identifier may alternatively be carried in both the first field and the second field. For examples, refer to corresponding descriptions in the foregoing embodiments. Details are not described herein again.

Manner 3: Both the measurement setup identifier and the measurement instance identifier are carried in the second field in the common information field of the sensing polling trigger frame.

For example, the trigger dependent common information field is expanded from less than or equal to 8 bits to greater than or equal to 8 bits in the manner 3. In this case, both the measurement setup ID and the measurement instance ID may be carried in the trigger dependent common information field of the sensing polling trigger frame.

### 3. Feedback Phase in the Sensing Measurement Scenario and the Hybrid Measurement Scenario

Based on the descriptions about the embodiment in FIG. 2a, after sending the sensing sounding trigger frame, the first device may further send a sensing reporting trigger frame to the second device, to trigger the second device to feed back the sensing measurement result of the second device to the first device.

For example, after S103 shown in FIG. 13, the following operations may be further included:

S21: The first device sends the sensing reporting trigger frame to the second device.

S22: The first device receives a second response frame for the sensing reporting trigger frame from the second device, where the second response frame includes the sensing measurement result of the second device.

In this embodiment, the second device is the sensing device (the ranging device does not accept the reporting trigger frame). Therefore, whether the sensing reporting trigger frame is compatible with the ranging device does not need to be considered.

In an embodiment, the sensing reporting trigger frame carries first indication information, the first indication information is carried in a second field in a common information field of the sensing reporting trigger frame, and a value of the first indication information in the sensing reporting trigger frame is a third value. It may be understood that the first indication information is indication information indicating a sensing trigger subtype, and is carried in a trigger dependent common information field. For example, the value of the first indication information in the sensing reporting trigger frame is 3 (that is, the third value is 3). When receiving the trigger frame, the second device may identify the trigger frame as a sensing reporting trigger frame.

The sensing reporting trigger frame carries a measurement setup identifier (measurement setup ID) used for sensing measurement and a measurement instance identifier (measurement instance ID) used for sensing measurement. In the sensing reporting trigger frame, manners in which the information is carried in the sensing reporting trigger frame may include but are not limited to the following manners:

Manner 1: The measurement setup identifier is carried in a first field or the second field in the common information field of the sensing reporting trigger frame, or carried in a user information list field of the sensing reporting trigger frame.

For example, the measurement setup ID may be carried in the trigger dependent common information field (as shown in FIG. 9, for example, B5 to B7 in FIG. 9) of the sensing reporting trigger frame, or may be carried in the first field (as shown in FIG. 7, for example, B54 to B62 in FIG. 7) in the common information field of the sensing reporting trigger frame, or may be carried in the user information list field (as shown in FIG. 11, for example, B12 to B20 in FIG. 11) of the sensing reporting trigger frame.

Manner 2: The measurement instance identifier is carried in the first field or the second field in the common information field of the sensing reporting trigger frame, or carried in the user information list field of the sensing reporting trigger frame.

For example, the measurement instance ID may be carried in the trigger dependent common information field (as shown in FIG. 9, for example, B5 to B7 in FIG. 9) of the sensing reporting trigger frame, or may be carried in the common information field (as shown in FIG. 7, for example, B54 to B62 in FIG. 7) of the sensing reporting trigger frame, or may be carried in the user information list field (as shown in FIG. 11, for example, B12 to B20 in FIG. 11) of the sensing reporting trigger frame.

Manner 3: Both the measurement setup identifier and the measurement instance identifier are carried in the second field in the common information field of the sensing reporting trigger frame.

For example, the trigger dependent common information field is expanded from less than or equal to 8 bits to greater than or equal to 8 bits in the manner 3. In this case, both the measurement setup ID and the measurement instance ID may be carried in the trigger dependent common information field of the sensing reporting trigger frame.

The second response frame may be, for example, the sensing report frame or the LMR frame described above. For an embodiment, refer to corresponding descriptions in 5 in part I. Details are not described herein again.

### 4. Second Indication Information Involved in the Polling Phase, the Measurement Phase, and the Feedback Phase

The second indication information is indication information for the sensing device in embodiments of this application. The second indication information indicates the sensing device to perform sensing measurement.

A sensing trigger frame carries the second indication information, and the sensing trigger frame is the sensing sounding trigger frame, or the sensing polling trigger frame, or the sensing reporting trigger frame described in the foregoing embodiments. In other words, the sensing sounding trigger frame, the sensing polling trigger frame, or the sensing reporting trigger frame described in the foregoing embodiments may carry the second indication information. In one embodiment, the second indication information is carried in a user information list field, or a first field or a second field in a common information field of the sensing trigger frame.

For example, the second indication information may be indicated by 1 bit. When the 1 bit is set to 0, it indicates the sensing device to perform sensing measurement. When the 1 bit is set to 1, a meaning of the 1 bit is not limited in this embodiment (for example, in the following embodiments, it may indicate the sensing device to perform ranging measurement). When the second indication information is indicated by 1 bit, the 1 bit may be carried in B63 of the common information field of the sensing trigger frame (including the sensing polling trigger frame, the sensing sounding trigger frame, and the sensing reporting trigger frame). Alternatively, the 1 bit may be carried in B4 of a trigger dependent common information field of the sensing trigger frame. Alternatively, the 1 bit may be carried in B39 of the user information list field of the sensing trigger frame.

III. Non-Trigger-Based Measurement Method (a Sensing Measurement Scenario Including a Sensing Device or a Sensing Measurement and Ranging Measurement Scenario Including a Sensing Device, and a Hybrid Measurement Scenario that does not Include the Sensing Device and a Ranging Device) Provided in Embodiments of this Application

FIG. 14 is a schematic flowchart of a non-trigger-based measurement method according to an embodiment of this application. The method is implemented through interaction between a first device and a second device, and includes the following operations:

S201: The second device sends a sensing null data packet announcement NDPA to the first device.

The sensing NDPA carries third indication information, and the third indication information indicates the first device to perform sensing measurement. It may be understood that the third indication information has a similar function as the second indication information described in the foregoing embodiments, that is, a sensing initiator indicates a sensing responder to specifically perform sensing measurement. The sensing NDPA carries a measurement setup identifier used for sensing measurement and a measurement instance identifier used for sensing measurement.

In one embodiment, manners in which the sensing NDPA carries the information may include but are not limited to the following several manners:

Manner 1: The third indication information is carried in a user information list field that corresponds to a sensing device and that is of the sensing NDPA, or carried in a special user information field, or carried in a sounding dialog token field of the sensing NDPA.

Manner 2: The measurement setup identifier is carried in the user information list field that corresponds to the sensing device and that is of the sensing NDPA, or carried in the special user information field, or carried in the sounding dialog token field of the sensing NDPA.

Manner 3: The measurement instance identifier is carried in the user information list field that corresponds to the sensing device and that is of the sensing NDPA, or carried in the special user information field, or carried in the sounding dialog token field of the sensing NDPA.

For the three implementations, refer to the descriptions about the user information list field or the special user information field that corresponds to the sensing device and that is of the NDPA in the foregoing embodiments. Details are not described herein again. It should be noted that the sensing NDPA in the foregoing embodiments is a trigger-based sensing NDPA, and the sensing NDPA in this embodiment is a non-trigger-based sensing NDPA. Therefore, the sensing NDPA in this embodiment does not carry a token value.

S202: The second device sends an initiator-to-responder null data packet I2R-NDP to the first device based on the sensing NDPA.

S203: The second device receives a responder-to-initiator null data packet R2I-NDP from the first device.

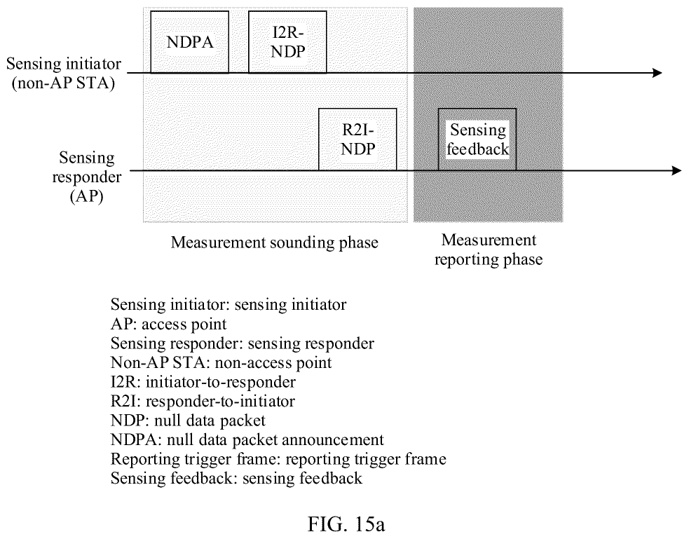

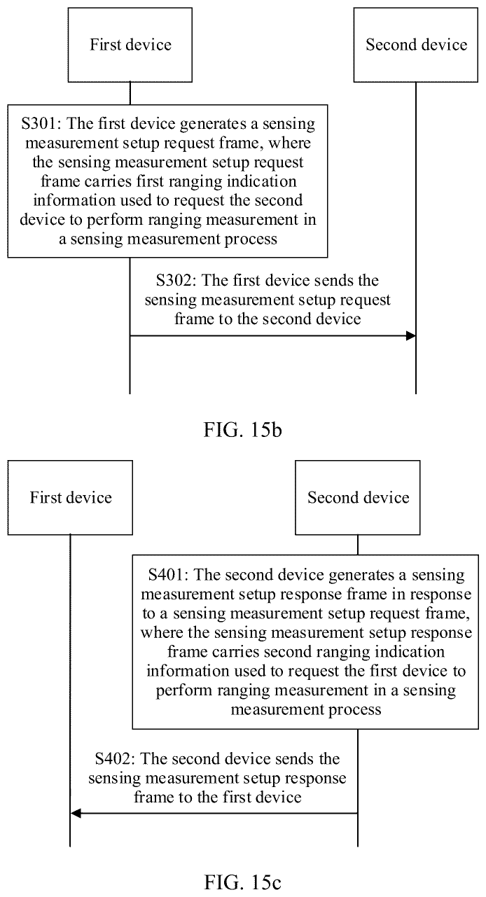

It should be noted that a non-trigger mechanism in this embodiment does not need a polling phase, and the second device directly sends the NDPA to the first device, to notify the first device that the second device is to send an initiator-to-responder null data packet (initiator-to-responder NDP, I2R-NDP). After receiving the NDP, an AP feeds back a responder-to-initiator null data packet (responder-to-initiator NDP, R2I-NDP). In addition, the I2R-NDP may be used for sensing measurement, or the R2I-NDP may be used for sensing measurement. In one embodiment, a measurement reporting phase is an additional phase. For example, FIG. 15a shows the measurement reporting phase. In the example, it indicates that the I2R-NDP is an NDP used for sensing measurement. Because the AP sends a measurement result to a non-AP STA, a trigger frame is not needed, and the AP may directly send sensing feedback to the non-AP STA.

In an embodiment, if the non-AP STA notifies, during previous parameter negotiation, the AP that both sensing and ranging are expected to be performed, the AP simultaneously or separately sends a ranging result and a sensing result to the non-AP STA in a result feedback phase. In this case, the sensing NDPA may include related information used by the sensing device for ranging. Alternatively, the non-AP STA may obtain the ranging measurement result in a manner in which the sensing device requires the AP to feed back the ranging measurement result in the sensing measurement report phase described in 5 in the foregoing, for example, feeding back the ranging measurement result via a format similar to that in FIG. 5b or Table 4 to Table 8, or that of the LMR frame. This is not limited in this application.

In an embodiment, if the non-AP STA notifies, during previous parameter negotiation, the AP that both sensing measurement and ranging measurement are expected to be performed, in a sensing measurement setup phase, the non-AP STA may implement parameter negotiation by using the operation in which the sensing device negotiates with the AP in the sensing measurement setup phase described in 5 in part I in the foregoing. Details are not described herein again.

IV. Another Trigger-Based Measurement Method (a Ranging Measurement Scenario Including a Sensing Device, and a Hybrid Measurement Scenario Including the Sensing Device and a Ranging Device) Provided in Embodiments of this Application

For operations of the measurement method in this embodiment, refer to operation S101 to operation S103 of the trigger-based measurement method described in the embodiment in FIG. 13, and the descriptions about the sensing polling trigger frame, the sensing sounding trigger frame, the sensing reporting trigger frame, and the like. A difference lies in that a sensing trigger frame (for example, including a sensing polling trigger frame, a sensing sounding trigger frame, a sensing reporting trigger frame, and the like) in the measurement method in this embodiment may be identified by the ranging device as a ranging trigger frame in the hybrid measurement scenario including the sensing device and the ranging device, so that the ranging device can perform ranging measurement based on the sensing trigger frame. This implements hybrid measurement based on the sensing trigger frame. In addition, the sensing trigger frame in the measurement method in this embodiment may be further used by the sensing device for ranging measurement, to enrich functions of the sensing device.

In this embodiment, the first device is a sensing AP, and the second device is a sensing non-AP STA or a ranging non-AP STA. In other words, the second device may be a sensing device or a ranging device. In this embodiment of this application, when the second device is a sensing device, in addition to performing sensing measurement, the sensing device may further perform ranging measurement, or may perform sensing measurement and ranging measurement.

The following describes a difference between this embodiment and the embodiment in FIG. 13.

1. A sensing sounding trigger frame is used to trigger the second device to send a first null data packet NDP. The first NDP is used for ranging measurement, or for sensing measurement and ranging measurement.

For example, in the hybrid measurement procedure of sensing and ranging shown in FIG. 4a, the AP may send the sensing sounding trigger frame to the sensing non-AP STA (namely, the sensing device) and the ranging non-AP STA (namely, the ranging device). Correspondingly, the sensing device and the ranging device receive the sensing sounding trigger frame, and separately perform corresponding measurement procedures.

Case 1: When the second device is the sensing device, and the second device is configured to perform ranging measurement, the sensing sounding trigger frame is used to trigger the second device to send the first NDP to the first device. In other words, the first NDP is a sensing NDP. However, the sensing NDP may carry information used for ranging measurement. This helps the sensing device perform ranging measurement based on the first NDP.

Case 2: In the hybrid measurement scenario, the second device may be considered as including the sensing device and the ranging device. The sensing sounding trigger frame is used to trigger the sensing device to send the sensing NDP to the first device, to trigger the ranging device to send a ranging NDP to the first device. In other words, the ranging device actually considers the sensing sounding trigger frame as a TF ranging sounding frame, and then performs ranging measurement.

For the ranging measurement described in the case 1 and the case 2, refer to the ranging measurement procedure described in FIG. 3a. Details are not described herein again.

2. The sensing sounding trigger frame carries a measurement setup identifier (measurement setup ID) used for sensing measurement and a measurement instance identifier (measurement instance ID) used for sensing measurement. In this embodiment, the second device may be the ranging device, that is, the combined procedure shown in FIG. 4a is performed between the first device and the second device. Because the ranging device exists, the sensing sounding trigger frame needs to be compatible with the ranging device. In embodiments of this application, lengths (namely, occupied bits) of the measurement setup ID and the measurement instance ID are not limited. For example, it is assumed that the length of the measurement setup ID is 3 bits, and the length of the measurement instance ID is 5 bits.

The measurement setup identifier and the measurement instance identifier are carried in a user information list field or a common information field of the sensing sounding trigger frame. For example, the measurement setup ID and the measurement instance ID may be carried in the common information field (as shown in FIG. 7, for example, B54 to B62 in FIG. 7) of the sensing sounding trigger frame, or may be carried in the user information list field (as shown in FIG. 11, for example, B12 to B20 in FIG. 11) of the sensing sounding trigger frame. It should be noted that in consideration of compatibility with the ranging device, a trigger dependent common information field (for example, a token domain) that is of the sensing sounding trigger frame and that can be identified by the ranging device cannot carry information used for sensing measurement.

3. The first device sends a null data packet announcement NDPA to the second device, where the NDPA is used to notify the second device that the first device is to send a second NDP. A sensing measurement result or a ranging measurement result of the second device is determined based on the second NDP.

The following cases are included:

Case 1: When the second device is the sensing device and needs to perform ranging measurement, or when the second device is the ranging device and needs to perform ranging measurement, the second device may identify the NDPA as an NDPA used for ranging measurement. When receiving the second NDP, the sensing device may measure the second NDP, and determine the ranging measurement result of the second device.

Case 2: When the second device is the sensing device and needs to perform sensing measurement, the NDPA is used to notify the second device that the first device is to send the sensing NDP used for sensing measurement. When receiving the second NDP, the sensing device measures the second NDP, to obtain CSI of a channel from the AP to the non-AP STA, that is, determining the sensing measurement result of the second device based on the second NDP.

In an embodiment, the NDPA carries one or more of the following information:
an association identifier, where the association identifier is associated with the sensing device;
second indication information, where the second indication information indicates the sensing device to perform sensing measurement;
the measurement setup identifier used for sensing measurement;
the measurement instance identifier used for sensing measurement; and
a token value used for ranging measurement.

It can be learned that compared with the NDPA in the embodiment in FIG. 13, the NDPA in this embodiment may further carry information related to ranging measurement (for example, the token value).

In the combined scenario including the sensing device and the ranging device, compatibility with the ranging device needs to be considered when the NDPA is designed. For example, manners in which the NDPA carries the information may include but are not limited to the following several manners:

Manner 1: The second indication information is carried in a user information list field that corresponds to the sensing device and that is of the NDPA, or carried in a special user information field of the NDPA, or carried in a sounding dialog token field of the NDPA. The second indication information is indication information newly added in embodiments of this application. For a description, refer to descriptions about the second indication information in 4 in the following.

Manner 2: The measurement setup identifier is carried in the user information list field that corresponds to the sensing device and that is of the NDPA, or carried in the special user information field of the NDPA, or carried in the sounding dialog token field of the NDPA. For example, the NDPA may use the frame format of the HE NDPA shown in FIG. 12a, a user information list field (for example, a user information list field 1) of the NDPA is set to the user information list field of the corresponding sensing device, and the measurement setup ID may be carried in the user information list field 1. For another example, the NDPA may use the frame format of the HE NDPA shown in FIG. 12a, a special user information field is newly added between the sounding dialog token field and the user information field. In this case, the measurement setup ID may be carried in the newly added special user information field. For another example, the NDPA may use the frame format of the HE NDPA shown in FIG. 12a, and the measurement setup ID may be carried in the sounding dialog token field. For the sensing device, the sensing device identifies that the sounding dialog token field carries the measurement setup ID. The ranging device identifies that the sounding dialog token field carries a sounding dialog token of the ranging device.

Manner 3: The measurement instance identifier is carried in the user information list field that corresponds to the sensing device and that is of the NDPA, or carried in the special user information field of the NDPA, or carried in the sounding dialog token field of the NDPA. For an example of the measurement instance ID, refer to the example of the measurement setup ID in the manner 2. Details are not described herein again.

Manner 4: The association identifier is carried in the user information list field that corresponds to the sensing device and that is of the NDPA, or carried in the special user information field of the NDPA. The user information list field or the special user information field further includes the association identifier (AID), and the association identifier is associated with the sensing device. For example, the AID of the user information list field is associated with the sensing device corresponding to the user information list field (for example, the AID is an ID of the corresponding sensing device). For another example, the AID of the special user information field may be associated with the sensing device. The AID herein is not an ID of a sensing device, but may be a special value that may be read by the sensing device.

Manner 5: The token value used for ranging measurement is carried in a user information list field that corresponds to the ranging device and that is of the NDPA. For example, the NDPA may use the frame format of the HE NDPA shown in FIG. 12a, a user information list field (for example, a user information list field 2) of the NDPA is set to the user information list field of the corresponding ranging device, and the token value may be carried in the user information list field 2.

That the sensing measurement result or the ranging measurement result of the second device is determined based on the second NDP includes the following:

For example, the second NDP is the sensing NDP sent by the first device (for example, the sensing AP) to the second device (for example, the sensing non-AP STA). In this case, the non-AP STA may measure the second NDP, to obtain the CSI of the channel from the AP to the non-AP STA, that is, determining the sensing measurement result of the second device based on the second NDP.

For another example, the second NDP is the sensing NDP sent by the first device (for example, the sensing AP) to the second device (for example, the ranging non-AP STA). However, it is assumed that the sensing NDP uses a same format as the ranging NDP, and may also carry information indicating ranging in this embodiment. In this case, the ranging non-AP STA may measure the second NDP, to obtain the CSI of the channel from the AP to the non-AP STA, that is, determining the ranging measurement result of the second device based on the second NDP.

4. Because the second device may be the sensing device or the ranging device, the first device sends a sensing polling trigger frame to the second device. Therefore, the second device feeds back a first response frame for the sensing polling trigger frame, to confirm whether the second device participates in a sensing measurement process or a ranging measurement process. A polling phase in this embodiment may be described by using the following several examples:

Example 1: Before the first device sends the sensing sounding trigger frame to the second device, the following operations may be further included:

S31: The first device sends the sensing polling trigger frame to the second device.

S32: The first device receives the first response frame for the sensing polling trigger frame from the second device, where the first response frame is used to confirm that the second device participates in ranging measurement.

In other words, the second device in the example is the sensing device or the ranging device. When the second device is the sensing device, the sensing device is also configured to perform ranging measurement.

Example 2: Before the first device sends the sensing sounding trigger frame to the second device, the following operations may be further included:

S41: The first device sends the sensing polling trigger frame to the second device.

S42: The first device receives the first response frame for the sensing polling trigger frame from the second device, where the first response frame is used to confirm that the second device participates in sensing measurement and ranging measurement.

In other words, the second device in the example includes the sensing device and the ranging device (hybrid measurement scenario). The first response frame fed back by the sensing device to the first device is used to confirm that the sensing device participates in the sensing measurement and the ranging measurement, and the first response frame fed back by the ranging device to the first device is used to confirm that the ranging device participates in the ranging measurement.

In an embodiment, the sensing polling trigger frame carries first indication information, the first indication information is carried in a second field in a common information field of the sensing polling trigger frame, and a value of the first indication information in the sensing polling trigger frame is a second value. It may be understood that the first indication information is indication information indicating a sensing trigger subtype, and is carried in a trigger dependent common information field. For example, the value of the first indication information in the sensing polling trigger frame is 1 (that is, the second value is 1). When receiving the trigger frame, the second device may identify the trigger frame as a sensing polling trigger frame.

In an embodiment, when the hybrid measurement procedure shown in FIG. 4a is performed between the first device and the second device, because the ranging device exists, the sensing polling trigger frame needs to be compatible with the ranging device. The sensing polling trigger frame carries a measurement setup identifier (measurement setup ID) used for sensing measurement, a measurement instance identifier (measurement instance ID) used for sensing measurement, and a token value used for ranging. In embodiments of this application, lengths (namely, occupied bits) of the measurement setup ID and the measurement instance ID are not limited. For example, it is assumed that the length of the measurement setup ID is 3 bits, and the length of the measurement instance ID is 5 bits.

The measurement setup identifier and the measurement instance identifier are carried in the common information field of the sensing polling trigger frame. For example, the measurement setup ID and the measurement instance ID may be carried in the common information field (as shown in FIG. 7, for example, B54 to B62 in FIG. 7) of the sensing polling trigger frame. It should be noted that in consideration of compatibility with the ranging device, a trigger dependent common information field (for example, a token domain) that is of the sensing polling trigger frame and that can be identified by the ranging device cannot carry information used for sensing measurement. The trigger dependent common information field (for example, the token domain) carries the token value used for ranging, that is, the carrying manner is the same as a carrying manner of an existing TF ranging poll frame. This helps the ranging device obtain information used for ranging.

5. In this embodiment, the sensing trigger frame (for example, including the sensing polling trigger frame, the sensing sounding trigger frame, and the sensing reporting trigger frame) also includes the second indication information described in the foregoing embodiments. However, the second indication information in this embodiment not only indicates the sensing device to perform sensing measurement, but also indicates the sensing device to perform ranging measurement or sensing measurement and ranging measurement. In one embodiment, the second indication information is carried in a user information list field, or a first field or a second field in a common information field of the sensing trigger frame.

For example, the second indication information may be indicated by 1 bit. When the 1 bit is set to 0, it indicates the sensing device to perform sensing measurement. When the 1 bit is set to 1, it indicates the sensing device to perform ranging measurement. When the second indication information is indicated by 1 bit, the 1 bit may be carried in B63 of the common information field of the sensing trigger frame (including the sensing polling trigger frame, the sensing sounding trigger frame, and the sensing reporting trigger frame). Alternatively, the 1 bit may be carried in B4 of a trigger dependent common information field of the sensing trigger frame. Alternatively, the 1 bit may be carried in B39 of the user information list field of the sensing trigger frame.

For another example, the second indication information may be indicated by 2 bits. When the 2 bits are set to 00, it indicates the sensing device to perform sensing measurement. When the 2 bits are set to 01, it indicates the sensing device to perform ranging measurement. When the 2 bits are set to 10, it indicates the sensing device to perform sensing measurement and ranging measurement. When the second indication information is indicated by 2 bits, the 2 bits may be carried in B54 to B62 of the common information field of the sensing trigger frame (including the sensing polling trigger frame, the sensing sounding trigger frame, and the sensing reporting trigger frame), or carried in B12 to B20 of the user information list field of the sensing sounding trigger frame.

V. Another trigger-based measurement method (for example, may be applied to a scenario in which a sensing device needs to be triggered to perform sensing measurement and ranging measurement, where the scenario may not include a ranging device) provided in embodiments of this application

### 1. Sensing Measurement Setup Phase

A. When a first device requires ranging measurement, the sensing measurement setup phase is implemented through interaction between the first device and a second device, as shown in FIG. 15b. The following operations are included:

S301: The first device generates a sensing measurement setup request frame, where the sensing measurement setup request frame carries first ranging indication information used to request the second device to perform ranging measurement in a sensing measurement process.

S302: The first device sends the sensing measurement setup request frame to the second device.

In an embodiment, the following operation is further included:

The second device sends a sensing measurement setup response frame to the first device.

B. When a second device requires ranging measurement, the sensing measurement setup phase is implemented through interaction between the second device and a first device, as shown in FIG. 15c. The following operations are included:

S401: The second device generates a sensing measurement setup response frame in response to a sensing measurement setup request frame, where the sensing measurement setup response frame carries second ranging indication information used to request the first device to perform ranging measurement in a sensing measurement process.

S402: The second device sends the sensing measurement setup response frame to the first device.

In an embodiment, before the second device generates the sensing measurement setup response frame, the following operation is further included:

The second device receives the sensing measurement setup request frame.

In an embodiment, the following operation is further included:

The first device sends a sensing measurement setup confirm frame to the second device.

For descriptions about the sensing measurement setup confirm frame, refer to corresponding descriptions in 5 in part I in the foregoing. Details are not described herein again.

In this embodiment, the first device is a sensing AP, and the second device is a sensing non-AP STA. In other words, the second device is a sensing device. For an embodiment of the foregoing operations, refer to corresponding descriptions in the hybrid measurement procedure of sensing and ranging in 5 in part I in the foregoing, for example, the frame format of the sensing measurement setup request frame and the frame format of the sensing measurement setup response frame. Details are not described herein again.

### 2. Sensing Measurement Instance Phase

A procedure of a trigger-based measurement method performed in the sensing measurement instance phase is similar to the procedure shown in FIG. 13. Details are not described herein again. A sensing polling trigger frame, a sensing sounding trigger frame, an NDPA frame, and an NDP that are sent by the AP in a measurement process are designed based on a frame format used for ranging measurement in the existing 802.11az protocol (the 802.11az protocol is based on the 802.11ax protocol). For an embodiment, refer to corresponding descriptions in II in the foregoing. Details are not described herein again. In addition, the first indication information, the second indication information, and how to carry the measurement setup identifier (measurement setup ID) and the measurement instance identifier (measurement instance ID) that are used for sensing measurement described in II and IV in the foregoing may all be reused in this embodiment. Details are not described herein again.

### 3. Sensing Measurement Report Phase

The sensing device also performs ranging measurement while performing sensing measurement. Therefore, in a result feedback phase, a ranging measurement result needs to be fed back. For a feedback manner, refer to descriptions in 5 in part I in the foregoing. For example, the AP may require the sensing device to feed back the ranging measurement result in the sensing measurement report phase, or the sensing device may require the AP to feed back the ranging measurement result in the sensing measurement report phase. Details are not described herein again.

It should be noted that embodiments described in I to V in this application may be cross-referenced. For example, the procedure of the trigger-based measurement method described in IV and V may reference the procedure and related descriptions shown in FIG. 13 in II. For another example, II and IV may also reference the operations in the sensing measurement setup phase and the sensing measurement report phase described in I and V. This is not limited in this application.

To implement functions in the method provided in this application, an apparatus or a device provided in this application may include a hardware structure and/or a software module. This implements the functions in a form of the hardware structure, the software module, or a combination of the hardware structure and the software module. Whether a function in the foregoing functions is performed in a form of the hardware structure, the software module, or both the hardware structure and the software module depends on an application and a design constraint condition of the technical solutions. Division into modules in this application is an example, and is merely logical function division. During actual implementation, another division manner may be used. In addition, functional modules in embodiments of this application may be integrated into one processor, each functional module may exist alone physically, or two or more modules may be integrated into one module. The integrated module may be implemented in a form of hardware, or may be implemented in a form of a software functional module.

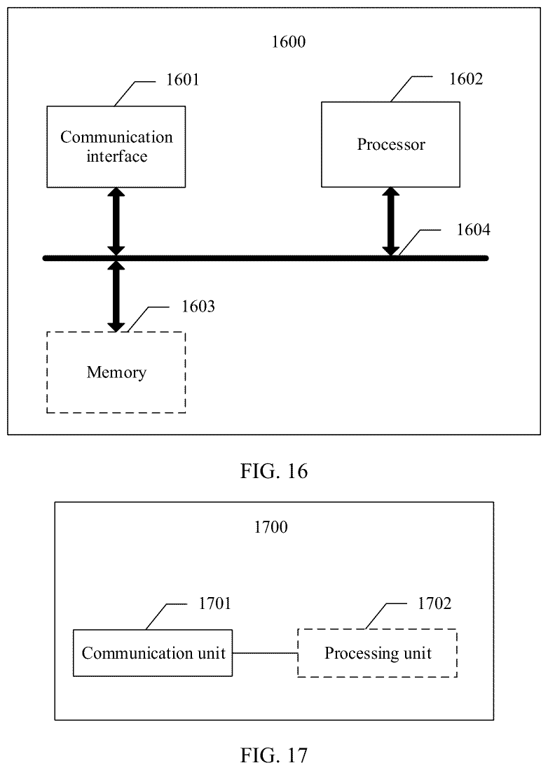

FIG. 16 shows a communication device 1600 according to this application. The device is configured to implement the measurement method in the foregoing method embodiments. The device may alternatively be a chip system. The device 1600 includes a communication interface 1601. The communication interface may be, for example, a transceiver, an interface, a bus, a circuit, or an apparatus that can implement a sending and receiving function. The communication interface 1601 is configured to communicate with another device through a transmission medium, so that an apparatus in the device 1600 is configured to communicate with another device. The device 1600 further includes at least one processor 1602. The communication interface 1601 is combined with the processor 1602, and is configured to implement the method in the foregoing method embodiments.

In an embodiment, the communication interface 1601 is configured to send a sensing sounding trigger frame to a second device. The sensing sounding trigger frame is used to trigger the second device to send a first null data packet NDP, and the first NDP is used to perform sensing measurement.

The communication interface 1601 is further configured to receive the first NDP.

The communication interface 1601 is further configured to send a second NDP to the second device. A sensing measurement result of the second device is determined based on the second NDP.

It can be learned that the sensing sounding trigger frame is sent by the first device to the second device. The sensing sounding trigger frame may be identified by the second device (for example, a sensing device), and a function of the sensing sounding trigger frame includes triggering the second device to send information related to sensing measurement to the first device, so that the sensing device can have a function of trigger-based sensing measurement.

The device 1600 in this embodiment of this application has any function of the first device in the first aspect in the summary and any function of the first device (AP) in the description of embodiments. For all technical details of the device 1600, refer to content corresponding to the first aspect in the summary and the description of embodiments. Details are not described herein again.

In another embodiment, the communication interface 1601 is configured to receive a sensing sounding trigger frame. The sensing sounding trigger frame is used to trigger a second device to send a first null data packet NDP, and the first NDP is used to perform sensing measurement.

The communication interface 1601 is further configured to send the first NDP.

The communication interface 1601 is further configured to receive a second NDP sent by the first device. A sensing measurement result of the second device is determined based on the second NDP.

It can be learned that the sensing sounding trigger frame may be identified by the second device (for example, a sensing device), and a function of the sensing sounding trigger frame includes triggering the second device to send information related to sensing measurement to the first device, so that the sensing device can have a function of trigger-based sensing measurement.

The device 1600 in this embodiment of this application has any function of the second device in the second aspect in the summary and any function of the second device (non-AP STA) in the description of embodiments. For all technical details of the device 1600, refer to content corresponding to the second aspect in the summary and the description of embodiments. Details are not described herein again.

In another embodiment, the communication interface 1601 is configured to send a sensing null data packet announcement NDPA to a first device.

The communication interface 1601 is further configured to send an initiator-to-responder null data packet I2R-NDP to the first device based on the sensing NDPA.

The communication interface 1601 is further configured to receive a responder-to-initiator null data packet R2I-NDP from the first device.

It can be learned that an AP may also participate in sensing as a sensing responder, and a sensing initiator is a non-AP STA. In this case, the sensing initiator can sense only one sensing responder at the same time. In other words, a sensing process described in this aspect is a sensing process with a non-trigger-based mechanism, that is, a one-to-one process. A sensing device may perform sensing measurement based on the I2R-NDP or the R2I-NDP.

The device 1600 in this embodiment of this application has any function of the second device in the third aspect in the summary and any function of the second device (non-AP STA) in the description of embodiments. For all technical details of the device 1600, refer to content corresponding to the third aspect in the summary and the description of embodiments. Details are not described herein again.

The device 1600 may further include at least one memory 1603, configured to store program instructions and/or data. In an implementation, the memory 1603 is coupled to the processor 1602. Couplings in this application are indirect couplings or communication connections between apparatuses, units, or modules, and may be electrical, mechanical, or in another form, and are used for information exchange between the apparatuses, the units, and the modules. The processor 1602 may operate with the memory 1603. The processor 1602 may execute the program instructions stored in the memory 1603. The at least one memory and the processor are integrated together.

In this application, a connection medium between the communication interface 1601, the processor 1602, and the memory 1603 is not limited. In this application, the memory 1603, the processor 1602, and the communication interface 1601 are connected through a bus 1604 in FIG. 16, and the bus is represented by a thick line in FIG. 16. A connection manner between other components is schematically described, and is not limited thereto. The bus may be classified into an address bus, a data bus, a control bus, and the like. For ease of description, the bus in FIG. 16 is represented by only one thick line, but which does not indicate that there is only one bus or one type of bus.

In this application, the processor may be a general-purpose processor, a digital signal processor, an application-specific integrated circuit, a field programmable gate array or another programmable logic device, a discrete gate or transistor logic device, or a discrete hardware component, and may implement or perform the methods, operations, and logical block diagrams disclosed in this application. The general-purpose processor may be a microprocessor or any conventional processor or the like. The operations of the methods disclosed with reference to this application may be directly implemented by a hardware processor, or may be implemented by a combination of hardware and a software module in a processor.

In this application, the memory may be a non-volatile memory, a hard disk drive (HDD) or a solid-state drive (SSD), or may be a volatile memory, for example, a random access memory (RAM). The memory is any other medium that can carry or store expected program code in a form of an instruction or a data structure and that can be accessed by a computer, but is not limited thereto. The memory in this application may alternatively be a circuit or any other apparatus that can implement a storage function, and is configured to store program instructions and/or data.

FIG. 17 is a diagram of a communication apparatus according to an embodiment of this application. The communication apparatus 1700 may include a communication unit 1701 and a processing unit 1702. The communication unit 1701 may include a sending unit and a receiving unit. The sending unit is configured to implement a sending function, the receiving unit is configured to implement a receiving function, and the communication unit 1701 may implement a sending function and/or a receiving function. The communication unit may also be described as a transceiver unit. The processing unit 1702 is configured to process data received/sent by the communication unit 1701.

In an embodiment, the communication unit 1701 is configured to send a sensing sounding trigger frame to a second device. The sensing sounding trigger frame is used to trigger the second device to send a first null data packet NDP, and the first NDP is used to perform sensing measurement.

The communication unit 1701 is further configured to receive the first NDP.

The communication unit 1701 is further configured to send a second NDP to the second device. A sensing measurement result of the second device is determined based on the second NDP.

It can be learned that the sensing sounding trigger frame is sent by the first device to the second device. The sensing sounding trigger frame may be identified by the second device (for example, a sensing device), and a function of the sensing sounding trigger frame includes triggering the second device to send information related to sensing measurement to the first device, so that the sensing device can have a function of trigger-based sensing measurement.

The communication apparatus 1700 in this embodiment of this application has any function of the first device in the first aspect in the summary and any function of the first device (AP) in the description of embodiments. For all technical details of the apparatus 1700, refer to content corresponding to the first aspect in the summary and the description of embodiments. Details are not described herein again.

In another embodiment, the communication unit 1701 is configured to receive a sensing sounding trigger frame. The sensing sounding trigger frame is used to trigger a second device to send a first null data packet NDP, and the first NDP is used to perform sensing measurement.

The communication unit 1701 is further configured to send the first NDP.

The communication unit 1701 is further configured to receive a second NDP sent by the first device. A sensing measurement result of the second device is determined based on the second NDP.

It can be learned that the sensing sounding trigger frame may be identified by the second device (for example, a sensing device), and a function of the sensing sounding trigger frame includes triggering the second device to send information related to sensing measurement to the first device, so that the sensing device can have a function of trigger-based sensing measurement.

The communication apparatus 1700 in this embodiment of this application has any function of the second device in the second aspect in the summary and any function of the second device (non-AP STA) in the description of embodiments. For all technical details of the apparatus 1700, refer to content corresponding to the second aspect in the summary and the description of embodiments. Details are not described herein again.

In another embodiment, the communication unit 1701 is configured to send a sensing null data packet announcement NDPA to a first device.

The communication unit 1701 is further configured to send an initiator-to-responder null data packet I2R-NDP to the first device based on the sensing NDPA.

The communication unit 1701 is further configured to receive a responder-to-initiator null data packet R2I-NDP from the first device.

It can be learned that an AP may also participate in sensing as a sensing responder, and a sensing initiator is a non-AP STA. In this case, the sensing initiator can sense only one sensing responder at the same time. In other words, a sensing process described in this aspect is a sensing process with a non-trigger-based mechanism, that is, a one-to-one process. A sensing device may perform sensing measurement based on the I2R-NDP or the R2I-NDP.

The communication apparatus 1700 in this embodiment of this application has any function of the second device in the third aspect in the summary and any function of the second device (non-AP STA) in the description of embodiments. For all technical details of the apparatus 1700, refer to content corresponding to the third aspect in the summary and the description of embodiments. Details are not described herein again.

This application further provides a communication system. The communication system includes the first device and the second device that are described in the method embodiments. In other words, based on the descriptions in the method embodiments, the communication system may implement, by using the first device and the second device, the measurement method described in this application.

This application provides a computer-readable storage medium. The computer-readable storage medium stores a program or instructions. When the program or the instructions is/are run on a computer, the computer is enabled to perform the measurement method described in the method embodiments.

This application provides a computer program product. The computer program product includes instructions. When the instructions are run on a computer, the computer is enabled to perform the measurement method described in the method embodiments.

This application provides a chip or a chip system. The chip or the chip system includes at least one processor and an interface. The interface and the at least one processor are interconnected through a line. The at least one processor is configured to run a computer program or instructions, to perform the measurement method in the method embodiments.

The interface in the chip may be an input/output interface, a pin, a circuit, or the like.

The chip system may be a system on chip (SOC), a baseband chip, or the like. The baseband chip may include a processor, a channel encoder, a digital signal processor, a modem, an interface module, and the like.

In an implementation, the chip or the chip system described above in this application further includes at least one memory, and the at least one memory stores instructions. The memory may be a storage unit inside the chip, for example, a register or a cache, or may be a storage unit (for example, a read-only memory or a random access memory) of the chip.

All or some of the technical solutions provided in this application may be implemented by using software, hardware, firmware, or any combination thereof. When software is used to implement the technical solutions, all or a part of the technical solutions may be implemented in a form of a computer program product. The computer program product includes one or more computer instructions. When the computer program instructions are loaded and executed on the computer, the procedure or functions according to this application are all or partially generated. The computer may be a general-purpose computer, a special-purpose computer, a computer network, a network device, a terminal device, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating one or more usable media. The usable medium may be a magnetic medium (for example, a floppy disk, a hard disk, or a magnetic tape), an optical medium (for example, a digital video disc (DVD)), a semiconductor medium, or the like.

In this application, when there is no logical conflict, embodiments may be mutually referenced. For example, methods and/or terms in the method embodiments may be mutually referenced, and functions and/or terms in the apparatus embodiments may be mutually referenced. For example, functions and/or terms between the apparatus embodiments and the method embodiments may be mutually referenced.

It is clear that a person skilled in the art can make various modifications and variations to this application without departing from the scope of this application. This application is intended to cover these modifications and variations of this application provided that they fall within the scope of protection defined by the following claims and their equivalent technologies.

1. A measurement method, comprising:
generating, by a first device, a sensing measurement setup request frame comprising first ranging indication information used to request a second device to perform ranging measurement in a sensing measurement process; and
sending, by the first device, the sensing measurement setup request frame to the second device.

2. The method according to claim 1, wherein
the first ranging indication information is in a sensing measurement parameters element of the sensing measurement setup request frame.

3. A communication apparatus, comprising:
at least one processor; and
a memory storing instructions that, when executed by the at least one processor, cause the at least one processor to:
generate a sensing measurement setup request frame comprising first ranging indication information used to request a second device to perform ranging measurement in a sensing measurement process; and
send the sensing measurement setup request frame to the second device.

4. The apparatus according to claim 3, wherein
the first ranging indication information is in a sensing measurement parameters element of the sensing measurement setup request frame.

5. The apparatus according to claim 3, wherein
the sensing measurement setup request frame further comprises a ranging measurement parameter; and
the ranging measurement parameter is in at least one of:
a ranging measurement parameters element newly added to the sensing measurement setup request frame; or
a ranging measurement parameters subfield newly added to a sensing measurement parameters element of the sensing measurement setup request frame.

6. The apparatus according to claim 3, wherein the at least one processor is further to:
send a sensing sounding trigger frame to the second device, wherein the sensing sounding trigger frame is used to trigger the second device to send a first null data packet (NDP), and the first NDP is used to perform at least one of sensing measurement or ranging measurement;
receive the first NDP; and
send a second NDP to the second device, wherein at least one of a sensing measurement result or a ranging measurement result of the second device is determined based on the second NDP.

7. The apparatus according to claim 6, wherein
the second device is a sensing device;
the sensing sounding trigger frame comprises a measurement setup identifier used for sensing measurement; and
the measurement setup identifier is in at least one of:
a first field or a second field in a common information field of the sensing sounding trigger frame; or
a user information list field of the sensing sounding trigger frame.

8. The apparatus according to claim 7, wherein
the sensing sounding trigger frame comprises a measurement instance identifier used for sensing measurement; and
the measurement instance identifier is in at least one of:
the first field or the second field in the common information field of the sensing sounding trigger frame; or
the user information list field of the sensing sounding trigger frame.

9. The apparatus according to claim 67, wherein
the sensing sounding trigger frame comprises first indication information;
the first indication information is in the second field in the common information field of the sensing sounding trigger frame; and
a value of the first indication information in the sensing sounding trigger frame is a first value.

10. The apparatus according to claim 6, wherein, before the sending a the sensing sounding trigger frame, the at least one processor is further to:
send a sensing polling trigger frame to the second device; and
receive a first response frame for the sensing polling trigger frame from the second device, wherein the first response frame is used to confirm that the second device participates in at least one of the sensing measurement or the ranging measurement.

11. The apparatus according to claim 10, wherein
the second device is a sensing device;
the sensing polling trigger frame comprises a measurement setup identifier used for sensing measurement; and
the measurement setup identifier is in at least one of a first field or a second field in a common information field of the sensing polling trigger frame.

12. A communication apparatus, comprising:
at least one processor; and
a memory storing instructions that, when executed by the at least one processor, cause the at least one processor to:
generate a sensing measurement setup response frame in response to a sensing measurement setup request frame, wherein
the sensing measurement setup response frame comprises second ranging indication information used to request a first device to perform ranging measurement in a sensing measurement process; and
send the sensing measurement setup response frame to the first device.

13. The apparatus according to claim 12, wherein
the second ranging indication information is in a sensing measurement parameters element of the sensing measurement setup response frame.

14. The apparatus according to claim 12, wherein
the sensing measurement setup response frame further comprises a ranging measurement parameter; and
the ranging measurement parameter is in at least one of:
a ranging measurement parameters element newly added to the sensing measurement setup response frame; or
a ranging measurement parameters subfield newly added to a sensing measurement parameters element of the sensing measurement setup response frame.

15. The apparatus according to claim 12, wherein the at least one processor is further to:
receive a sensing sounding trigger frame, wherein the sensing sounding trigger frame is used to trigger a second device to send a first null data packet (NDP), and the first NDP is used to perform at least one of sensing measurement or ranging measurement;
send the first NDP to the first device;
receive a null data packet announcement (NDPA) sent by the first device, wherein the NDPA is used to notify the second device that the first device is to send a second NDP; and
receive the second NDP sent by the first device, wherein at least one of a sensing measurement result or a ranging measurement result of the second device is determined based on the second NDP.

16. The apparatus according to claim 15, wherein
the second device is a sensing device;
the sensing sounding trigger frame comprises a measurement setup identifier used for sensing measurement; and
the measurement setup identifier is in at least one of:
a first field or a second field in a common information field of the sensing sounding trigger frame; or
a user information list field of the sensing sounding trigger frame.

17. The apparatus according to claim 16, wherein
the sensing sounding trigger frame comprises a measurement instance identifier used for sensing measurement; and
the measurement instance identifier is in at least one of:
the first field or the second field in the common information field of the sensing sounding trigger frame; or
the user information list field of the sensing sounding trigger frame.

18. The apparatus according to claim 16, wherein
the sensing sounding trigger frame comprises first indication information;
the first indication information is in the second field in the common information field of the sensing sounding trigger frame; and
a value of the first indication information in the sensing sounding trigger frame is a first value.

19. The apparatus according to claim 15, wherein before the receiving the sensing sounding trigger frame, the at least one processor is further to:
receive a sensing polling trigger frame; and
send a first response frame for the sensing polling trigger frame to the first device, wherein the first response frame is used to confirm that the second device participates in at least one of the sensing measurement or the ranging measurement.

20. The apparatus according to claim 19, wherein
the second device is a sensing device;
the sensing polling trigger frame comprises a measurement setup identifier used for sensing measurement; and
the measurement setup identifier is in at least one of a first field or a second field in a common information field of the sensing polling trigger frame.
